(19) United States
(12) Patent Application Publication
(10) Pub. No.: US 2001/0037204 A1
(43) Pub. Date: Nov. 1, 2001

(54) System and method for on line resolution of disputes

(76) Inventors: John R. Horn, Sherman Oaks, CA (US); Vanessa C.L. Chang, Los Angeles, CA (US); Roland W. Schoettler, Los Angeles, CA (US)

Correspondence Address: F. Jason Far-hadian, SKJERVEN, MORRILL, MacPHERSON LLP, Suite 700, 25 Metro Drive, San Jose, CA, 95110-1349, US

(21) Appl. No.: 09/756,408

(22) Filed: Jan. 8, 2001

Related U.S. Application Data
(60) Provisional application No. 60/204,044, filed on May 12, 2000.

(51) Int. Cl. G06F 17/60

(52) U.S. Cl. 705/1

(57) ABSTRACT

One or more embodiments of the invention are directed to an on line system that facilitates the confidential and secure exchange of offers and demands between parties to a dispute. The exchange can take place directly between a claimant and a respondent or their representatives without the involvement of third parties, such as mediators or arbitrators. The system is designed to minimize overhead costs by automatically reminding the parties of a pending settlement offer at selected time intervals, thereby eliminating the need for constant follow up correspondence and telephone calls. System features encourage settlement of disputes by providing a user-friendly environment and an easily accessible medium for exchange of information related to a dispute. Parties are invited to submit settlement offers in ranges including minimum and maximum dollar amounts for which they are willing to settle the case. Based upon the submitted offers the system determines a settlement amount that fits within the proposed ranges. If no settlement is reached the parties are invited to try again.

### BACKGROUND

1. Field of the Invention

This invention relates to interactive computer software and, more particularly, to a method and apparatus for resolving disputes using the Internet.

Portions of this document, including the microfiche Appendix 1, contain material that is subject to copyright protection. These copyrights are hereby reserved to the applicant or assignees thereof. However, the applicant has no objection to the reproduction of all or portions of the document, to the extent necessary for the purposes of filing, prosecuting, or publishing this application or any patent to issue thereon in the United States Patent and Trademark Office or any foreign Patent Office.

2. Prior Art

Disputes arise frequently. Unfortunately, not many of them are easily resolved. Typically, to resolve a dispute, a party in dispute (the “claimant”) initiates a claim or request for payment for a loss or injury caused by other parties to the dispute. An accused party is generally expected to respond to a claimant's request and therefore is known as the respondent.

Many claims involve injuries caused to the person or property of a claimant. Asserted claims are, at times, handled and processed by a casualty or property insurer that insures the respondent. Due to the sheer volume of claims filed against insurers, such as State Farm or All State insurance companies, insurers have developed systematic methods to process, evaluate, adjust, and resolve injury claims. Unfortunately, the current methods are unsatisfactory because they are associated with lengthy delays and high overhead costs. For example, a typical claim is settled in approximately 12 to 18 months. The longer it takes to settle a claim the more expensive is the claim negotiation process and the more dissatisfied are the parties involved in the process. Further, the overhead and claims management expenses are among the largest expenses incurred by insurance companies, representing 60% of net revenues generated by them. The United States property and casualty industry, in 1998, paid out $178 billion in losses and incurred an additional $37 billion in loss adjustment expenses.

The dissatisfaction and high cost associated with resolving insurance related disputes are partially due to the inefficiency of the current methods of investigating and negotiating claims. For example, in many cases information collected in the early stages of claim negotiation is insufficient and inaccurate because the information is exchanged between multiple parties before it reaches the insurer. Further, even after the necessary information is gathered, extensive written correspondence and lengthy telephonic or face-to-face communications are exchanged before a resolution is reached. To maximize profits, insurers have attempted to offset the operation loss and the overhead costs by minimizing loss payments to their insured or a third party claimant. As a result of this practice, the insured and claimant are often treated unfairly and may receive low settlement offers in relation to the actual value of their loss.

An efficient method for dispute resolution is needed that can reduce the overhead costs associated with handling a claim. With the advent of the computer age, especially the Internet, new solutions can be provided to overcome the above referenced shortcomings. This invention, its advantages and improvements over the prior art schemes, will be better understood and appreciated by reviewing the following discussion of the traditional methods of dispute resolution and the current Internet related schemes available for resolving disputes.

Traditional Method of Handling a Loss claim

Traditionally, a claim is assigned to a claim adjuster who works for the insurer. The adjuster is responsible for investigating the particulars of a loss, including the amount of loss, nature of injuries, and other information related to the event leading to the loss. Due to the limited supply of trained human resources, overhead costs associated with training of qualified personnel, and increase in the number of filed claims, the cost for handling claims in the traditional way is increasing. Some insurers have developed loss control mechanisms and have implemented outsourcing schemes to reduce overhead and claims management expenses.

Despite the above efforts to reduce costs, due to the complexity of the cases and the number of parties involved, an insurance adjuster has to spend much time to coordinate and correspond with all involved parties in a dispute. For example, numerous letters of representation and requests for production of various documents are generally exchanged between parties and/or the parties' representatives. Further, once all information is gathered the parties have to communicate on numerous occasions before a resolution is reached. Unfortunately, quite often the claimant and respondent representatives or attorneys are unable to accept or respond to communication attempts of the other party in a timely fashion. As such, the settlement process is delayed and postponed indefinitely until the parties can meet or discuss the matter.

Furthermore, even when the parties manage to discuss settlement, the negotiations are unsuccessful because the parties fail to engage in good faith settlement negotiations by offering or requesting the actual value for a case. Very often the initial offers and demands are so far from the actual value of the case that negotiations are discontinued at inception. As a result, instead of reaching a settlement the parties incur additional unnecessary costs on behalf of their insured or client by getting involved in or threatening protracted litigation. A dispute resolution method is needed that encourages the settlement of disputes by motivating parties to submit reasonable, good faith offers or demands and avoiding the traditional negotiation techniques that delay the process.

Current Internet Related Schemes for Dispute Resolution

Currently, two web sites namely “CyberSettle.com” and “clickNsettle.com” provide dispute resolution services via the Internet. CyberSettle.com is majorityowned by NACRe, a large insurance company. NACRe has invested over $9.5 million in the development of the web site. Cybertsettle.com charges $30 to $75 for each claim submitted by an insurer. As illustrated in FIGS. 1 and 2, CyberSettle allows the user to submit three rounds of offers and demands. If the offer is the same or greater than the demand, the claim is settled for the demand amount. If an offer is within 30% or $5,000 of the demand, the claim is settled for median amount. If the offer differs by more than 30% or $5,000 from the demand in all three rounds, the claim will not settle. CyberSettle.com charges an additional fee to each party if the claim settles. For example, an additional $10 is charged for settlements with a value less than $5,000. For claims equal to or greater than $5,000, but less than $10,000, and additional amount of $150 is charged, and $200 is charged for claims equal to or in excess of $10,000. Further, a flat fee of $50 is charged for all lien claims.

ClickNsettle.com is a wholly owned subsidiary of National Arbitration and Mediation (“NAM”). FIG. 3 illustrates the Internet web site that explains how mediation process through ClickNsettle works. The site is used to drive mediation and arbitration business to NAM. ClickNsettle.com charges each party a fee of $15 for initiating a claim, an opening offer, and a demand. Thereafter, $10 is added for each new offer and demand. The settlement fees to each party include $100 for settlements equal to or less than $10,000 and $200 for claims in excess of $10,000.

The disadvantage of the above services is that the user has to pay an initial fee even if his dispute is not resolved using the service. Also, the above-mentioned services fail to take into account dispute scenarios where multiparty claimants and respondents may be present. Additionally, none of the current services allow a party to enter a settlement range to settle a dispute, nor do they provide the parties with a common or private forum for evaluating similar cases.

### SUMMARY

In accordance with this invention, on line systems and methods are provided that facilitate the confidential and secure exchange of offers and demands between parties to a dispute. The exchange can take place directly between a claimant and a respondent or their representatives without the involvement of third parties, such as mediators or arbitrators. One embodiment of the system is designed to minimize overhead costs by automatically reminding the parties of a pending settlement offer at selected time intervals, thereby eliminating the need for constant follow up correspondence and telephone calls. This system encourage settlement of disputes by providing a user-friendly environment and an easily accessible medium for exchange of information related to a dispute.

One objective of the system is to collaborate with the claims settlement practices of the insurance industry as an independent, trustworthy medium through which insurance related claims and disputes can be settled. Due to the system's cost saving and automated reminder features, insurers, claimants, respondents, and their representatives can efficiently and simply resolve their disputes. Insurance company claim adjusters and plaintiffs' attorneys can especially benefit from the use of the system because it will save them time and money by assisting them to automatically process, track, and settle a large volume of cases.

Embodiments of the invention can be equally used to resolve personal and family disputes or general matters involving commercial transactions, including offers to purchase, and any disputes arising therefrom. Multi-party disputes and other types of transactions such as collection matters can be also resolved using the system. Compiling the information gathered from the users, the system also provides industry metrics and reports that can be customized to provide confidential management information specific to a company or industry that uses the services provided by the system.

In one or more embodiments of the invention, a user (e.g., a party to a dispute or claimant) initiates the negotiation process by logging onto the system, via an Internet web site for example. The user is then prompted to provide information for setting up a claim, such as billing information, parties index information, nature of the claim, and date of loss. The system then notifies the parties that if a settlement is reached through the system it is binding and that non-performance of the settlement constitutes a breach of contract.

Once the user has provided information, the system prompts the user to select a desired increment amount from which the system can generate a series of settlement ranges. Upon providing the desired increment amount, the user is prompted to choose a settlement range from a preset menu of multiple ranges calculated based on the increment amount. Alternatively, the user can select a specific range by directly entering it into the system. In certain embodiments, the system provides the user with a unique reference number to identify the claim. For example, an identification number and password will be provided to the user for future reference. Using this identification information, the user can track the status of the claim by logging into the system. Additionally, the opposing party receives his or her unique separate ID and password so that he or she can respond to an offer submitted by the initiating party for that claim.

Information entered into the system by the users is compiled and recorded in a database for future retrieval and access. After the system records the information provided by the user, it contacts the adverse party via email or other communication means (e.g., post office mail, fax) to notify the party of the initiation of a claim and an offer. The system invites the adverse party to participate if he wishes to resolve the dispute via the system. A password and identification number are provided to the adverse party, for example, so that the adverse party can reference the appropriate claim when using the system to respond. In one or more embodiments, the offer and demand values and ranges remain confidential and are not revealed to either party.

To respond to a system invitation initiated by a party, the adverse party (i.e., the respondent) logs onto the system. After providing the information for identifying a claim, the system prompts the party to select a settlement range that reflects a reasonable value for the settlement of the dispute. The adverse party may elect from one of many pre-determined ranges automatically generated by the system based on the increments selected by the initiating party, but unknown to adverse party. Alternatively, the adverse party may provide a specific range other than that provided by the system. Once the adverse party has provided the settlement range, the system determines a settlement amount based on predetermined settlement parameters (e.g., the upper and lower limits of each range).

In embodiments of the invention, in order to calculate a settlement amount, the system considers the upper and lower limits of ranges offered for settlement by the claimant and the respondent. Thus, four range limits are selected by the parties. They include the minimum amount acceptable to a claimant, the maximum amount requested by the claimant, the minimum payment offered by the respondent, and the maximum payment offered by the respondent. If the maximum amount requested by the claimant is less than or equal to the minimum payment offered by the respondent, then the settlement value is the maximum amount requested by the claimant. For example, if the claimant chooses a range of $1,000 to $2,000 to settle the claim and the respondent chooses a range of $4,000 to $8,000 to settle the claim, then the system calculates $2,000 as the settlement amount.

If the minimum amount acceptable to the claimant is more than the maximum payment offered by the respondent, then no settlement is reached (e.g., claimant's range is $10, 000 to $20,000 and the respondent's range is $5,000 to $8,000). Otherwise, the system sorts the above four range limits either in the ascending or descending order. Then, the system selects the midpoint between the second and third limits as the settlement amount. Thus, for example, if one party has selected a range of $1,000 to $3,000 and the other party has selected a range of $2,000 to $10,000 the system, in one embodiment, sorts the four limits from $1,000 to $10,000 (e.g., $1,000, $2,000, $3,000, and $10,000). The settlement amount is calculated as the midpoint between $2,000 (the second limit) and $3,000 (the third limit) at $2,500.

The above method encompasses other circumstances where selected ranges overlap. For example, if both parties have selected the same exact settlement range (e.g., both claimant and respondent select $1,000-$3,000) then the dispute is resolved for the midpoint of that range (e.g., $2,000). If selected ranges are contiguous (e.g., claimant selects $1,000 to $2,000 and respondent selects $2,000 to $10,000) then the settlement amount is the point of intersection (e.g., $2,000). When a settlement is reached the system notifies the parties of the settlement amount and status.

The system, in some embodiments, displays information about the status of a claim by utilizing a claim status indicator for each party. For example, if an offer for settlement has been initiated by a party but the other party has not yet replied, an offer pending status indicator will be displayed. If the other party has replied but no settlement has been reached, then the status indicator will indicate that the first round of negotiations has been completed but no resolution has been reached. Other means for notification are possible (e.g., email, written correspondence). In some embodiments, if a party fails to participate in the negotiation process, the system automatically sends the party reminders of a pending offer at certain time intervals (e.g., once a week). Time to respond also expires after a certain time period (e.g., one month) has passed. In some embodiments, the system gives the initiating party the option to withdraw the offer and notifies the other party of a possible impending withdrawal or expiration date, in advance.

In instances where a settlement is not reached, the system allows the parties to enter into a second round of negotiations by selecting entirely new ranges of settlement or requesting the system to automatically broaden the previously selected ranges. Parties can rely on status indicators to determine whether to initiate a second round. In one embodiment, for example, the system broadens the selected ranges by a certain percentage of the difference between the highest and lowest amounts in each settlement range. In one or more embodiments, the system may broaden each range by 50%, for example. Thus, if one party has initially selected a range between $5,000 to $6,000 and chooses to participate in the second round, by selecting a broader range instead of an entirely new range then the system extends the range by $500 (i.e., 50% of the increment by which the upper and lower limits of the settlement range differ from each other). As such, the new settlement range offered in the second round by the responding party will be $4,500 to $6,500.

Broadening the selected ranges allows the parties to get closer to a common ground for settlement without substantially compromising their positions from one round to the next. If the ranges calculated in the second round overlap or meet, then a settlement is reached based on the above-described methods; otherwise the parties can try again. In certain embodiments, the parties cannot make more than one offer for settlement at each round. Thus, in order to make another offer of settlement on a claim, a party has to wait for the other party to respond. This feature encourages parties to provide their best possible offers at earlier rounds to avoid prolonged settlement negotiations and prevents parties from submitting multiple settlement offers successively to guess the other party's pending offer.

In case of a settlement, the system notifies both parties that a settlement has been reached for a certain amount. If no settlement is reached, a party can submit blind new offers or communicate with the other through a confidential on line bulletin board that is set up specifically for each claim. The process can be repeated until a settlement is reached. In some embodiments, there is an absolute deadline (e.g., 12 months) to reach a settlement. If parties have not settled by the deadline the claim is removed from the system. In certain embodiments, the system warns the parties of legal statutory deadlines, such as the relevant Statutes of Limitation for filing a lawsuit and other bar dates.

In some embodiments, an initial offer remains outstanding for a predetermined amount of time (e.g., 30 days) and can be withdrawn thereafter if the other party has not responded within that time. One or both parties can retrieve and automatically generate a settlement agreement from the system if a settlement has been reached. Each party is billed, regardless of the settlement amount, when the claim settles. There is no charge to the parties if the claim is not settled.

### BRIEF DESCRIPTION OF THE DRAWINGS

FIGS. 1 through 3 are examples of prior art web sites that provide on line dispute resolution services.

FIG. 4 illustrates the on line client server model of the system, according to one or more embodiments.

FIGS. 5A and 5B illustrate block diagrams of the hardware and software components of the system, according to one or more embodiments.

FIG. 6 is a flow diagram illustrating the various menu options provided by the system, according to one or more embodiments.

FIGS. 7 through 33 and 35 through 42 illustrate examples of web pages implemented and displayed by the system to a system user, according to one or more embodiments.

FIG. 7 is an example of a homepage displayed by the system, according to one or more embodiments.

FIGS. 8 through 12 are examples of web pages displayed by the system that contain information about the manner in which the system works, according to one or more embodiments.

FIGS. 13 and 14 are examples of web pages displayed by the system that contain information about the advantages of the system, according to one or more embodiments.

FIGS. 15 through 17 are examples of web pages, according to one or more embodiments of the system that contain information about the founders of the system.

FIGS. 18 through 21 are examples of web pages, according to one or more embodiments of the system, that contain information about the fees, customer service, and security features of the system.

FIG. 22 is an example of a web page displayed by the system for receiving party information, according to one or more embodiments.

FIG. 23 is an example of a web page displayed by the system for receiving payment information, according to one or more embodiments.

FIG. 24 is an example of a web page displayed by the system for setting up system access information, according to one or more embodiments.

FIG. 25 is an example of a web page displayed by the system for receiving company information, according to one or more embodiments.

FIG. 26 is an example of a web page displayed by the system for congratulating a party for successfully completing system registration, according to one or more embodiments.

FIG. 27 is an example of a web page displayed by the system to a party who wishes to log onto the system, according to one or more embodiments.

FIGS. 28 and 29 are examples of web pages displayed by the system indicating the status of one or more claims, according to one or more embodiments.

FIG. 30 is an example of a web page displayed by the system prompting the user to enter information to initiate a new claim, according to one or more embodiments.

FIG. 31 is an example of a web page displayed by the system prompting the user to select a type of loss, according to one or more embodiments.

FIG. 32 is an example of a web page displayed by the system providing a user with the choice to add or delete information related to a claim, according to one or more embodiments.

FIG. 33 illustrates an example of a web page, according to one or more embodiments, where a user can select a settlement range from a menu of various settlement ranges.

FIG. 34 illustrates a flow diagram of a method of resolving disputes, according to one or more embodiments.

FIG. 35 illustrates an example of a web page, according to one or more embodiments, alerting the users of potential settlement amounts based upon the range and option selected by the user.

FIG. 36 is an example of a web page displayed by the system containing the terms and conditions of the settlement, according to one or more embodiments of the system.

FIG. 37 is an example of a web page displayed by the system confirming completion of the filing of the claim, according to one or more embodiments of the system.

FIG. 38 is an example of a web page displayed by the system, according to one or more embodiments, indicating that the filing of a claim has been aborted.

FIG. 39 is an example of a web page displayed by the system providing a user with a portfolio of all claims handled by the user and the status of each claim, according to one or more embodiments of the system.

FIG. 40 is an example of a web page displayed by the system, according to one or more embodiments, prompting the responding party to enter a settlement amount.

FIG. 41 is an example of a web page displayed by the system congratulating and notifying the parties that a settlement is reached, according to one or more embodiments.

FIG. 42 is an example of a web page displayed by the system indicating that no settlement has been reached, according to one or more embodiments of the system.

FIG. 43 illustrates a flow diagram of a method of renegotiating a dispute, according to one or more embodiments of the system.

FIG. 44 illustrates a flow diagram of a method of determining a settlement amount, according to one or more embodiments of the system.

### DETAILED DESCRIPTION

The invention is directed to methods, systems, and apparatus for on line resolution of disputes. In embodiments of the invention, parties to a dispute can utilize the system to log onto a web site developed by a service provider of on line alternative dispute resolution services. The service provider is an entity to which the parties to a dispute subscribe in order to be able to utilize the services provided by the system. The parties to the dispute can, for example, include private individuals or entities involved in a dispute, government entities or corporations such as collection agencies or insurance companies that deal with numerous claims submitted by various claimants, and the representatives of those claimants.

In the following, numerous specific details are set forth to provide a thorough description of embodiments of the invention. Of course, the invention may be practiced without some specific details or some variations in details.

System Architecture

In one or more embodiments of the invention, a computer system architecture is utilized to accept and process demands and offers submitted by parties in a dispute and to handle the communication of all information among the parties involved in the process. Typically, a computer system architecture is composed of two distinct environments, a software environment and a hardware environment. The hardware environment, as it is discussed in further detail below, includes the machinery and equipment (e.g., CPU, disks, tapes, modem, cables) that provide an execution environment for the software. On the other hand, the software environment provides the execution instructions for the hardware environment.

In operation, a computer needs both the hardware and software environments to function. One is useless without the other. The software environment can be divided into two major categories, including system software and application software. As it is further discussed below, system software is made up of control programs, such as the operating system (OS) and information management systems, that instruct the hardware how to function and process information. Application software is a program that more directly interacts with a user and processes specific information for a user. In short, typically, the hardware environment specifies the commands it can follow and the software environment instructs it what to do. With the current advances in the technology, though, systems can be designed where system functions can be interchangeably implemented in hardware or software environments.

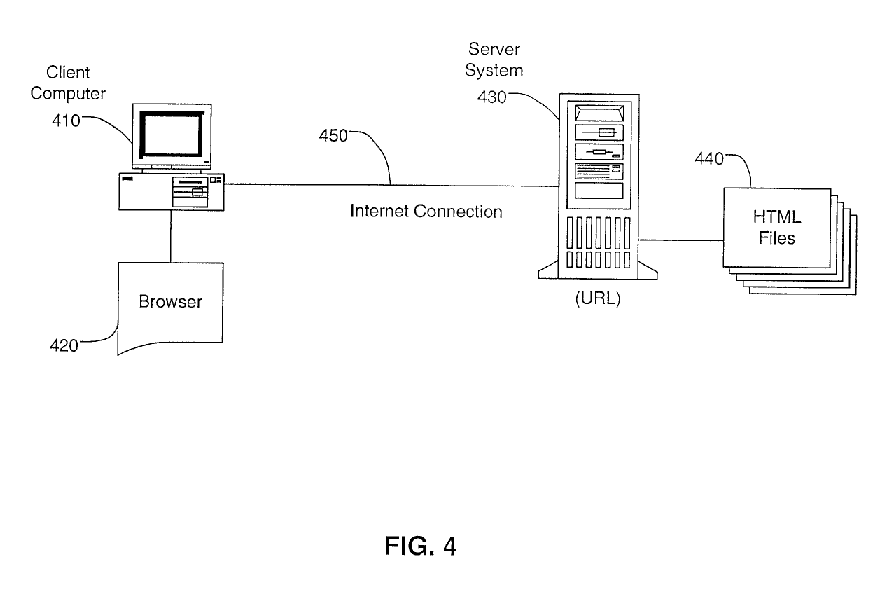

FIG. 4 illustrates an on line client server architecture, according to one or more embodiments of the system, where a party to a dispute communicates with a service provider via the Internet using a client computer 410. In one or more embodiments, the system software and the application software that implement the on line system are at least partially installed on one or more server systems, such as server system 430. The services provided by the system are available via Internet connection 450 to parties and companies who have established an account with the service provider. Internet connection 450 connects client computers utilized by the parties (e.g., computer 410) to service provider's server system 430. Computer 410 can be utilized by a party to make an offer for settlement. Server system 430 is configured to evaluate the offers submitted and calculate a settlement amount that is agreeable to all parties.

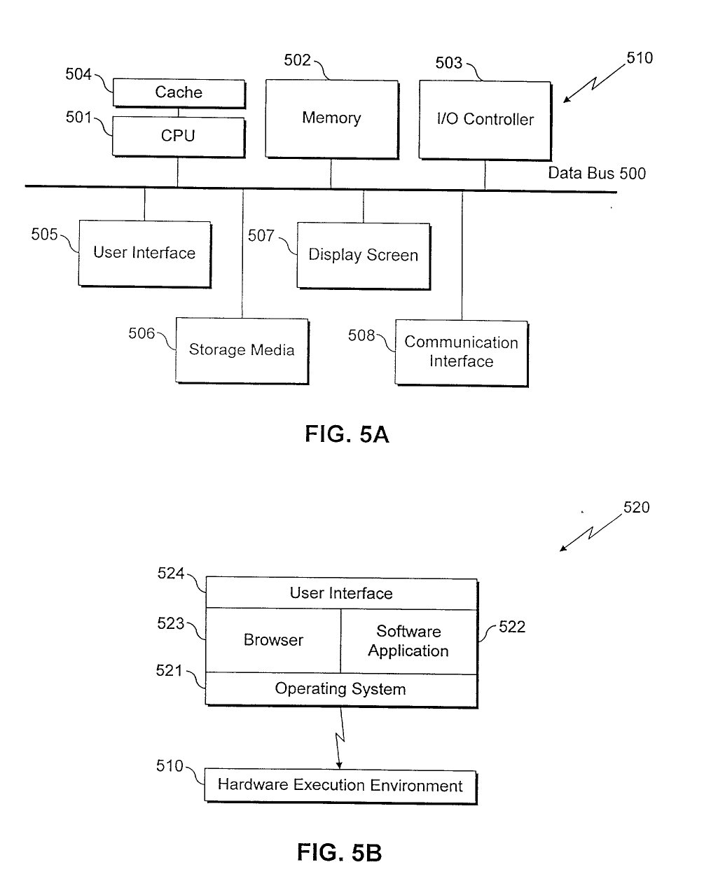

The client and server computer systems, in one or more embodiments include hardware and software components and system architectures that are suitable for the operation of the application software of this invention. The various hardware and software components of the above client and server architectures are illustrated in FIGS. 5A and 5B. This invention, including the application software for resolving disputes via the Internet, in one or more embodiments, can be implemented in association with hardware system 510 (FIG. 5A) and software system 520 (FIG. 5B) as described in further detail below.

The following hardware and software systems are provided by way of example only. The invention may be practiced either individually or in combination with other suitable hardware or software architectures or environments.

Application Software for a Method of Resolving Disputes

One or more embodiments of the invention are directed to an on line system and method for resolving disputes. Referring to FIG. 4, parties to a dispute can use computer equipment, such as computer 410, to submit offers and demands for settlement of disputes, using the application software of this system.

As illustrated in FIG. 4, computer 410 is either a stand-alone computer or is connected to service provider's server system 430 via Internet connection 450 in a worldwide network. Client computer 410 and server system 430 are utilized to provide the hardware and software execution environment for the application software. The application software is executed partly or fully on server system 430 or client computer 410. Server system 430 processes submitted requests and controls, manages, and directs data communication to and from client computer 410. Server system 430 may include one or more server computers and other resources that are necessary to provide communication and data management services.

To start the process, an initiating party to a dispute accesses the service provider's web site using client computer 410, for example, by referencing the Uniform Resource Locator (URL) of the web site (e.g., ResolveINow.com). The request including the URL reference for the provider's web site is received by server system 430 through Internet connection 450. Server system 430 then forwards to client computer 410 HTML files 440 that make up the web pages referenced by the submitted URL. Browser 420 parses the transferred HTML files 440 and causes their content to be displayed to the initiating party.

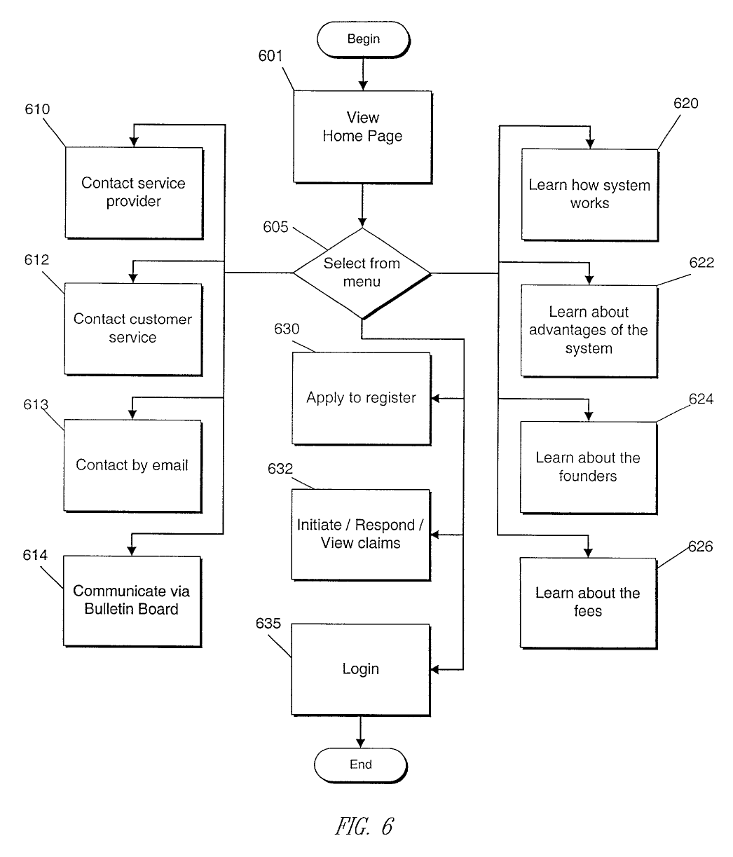

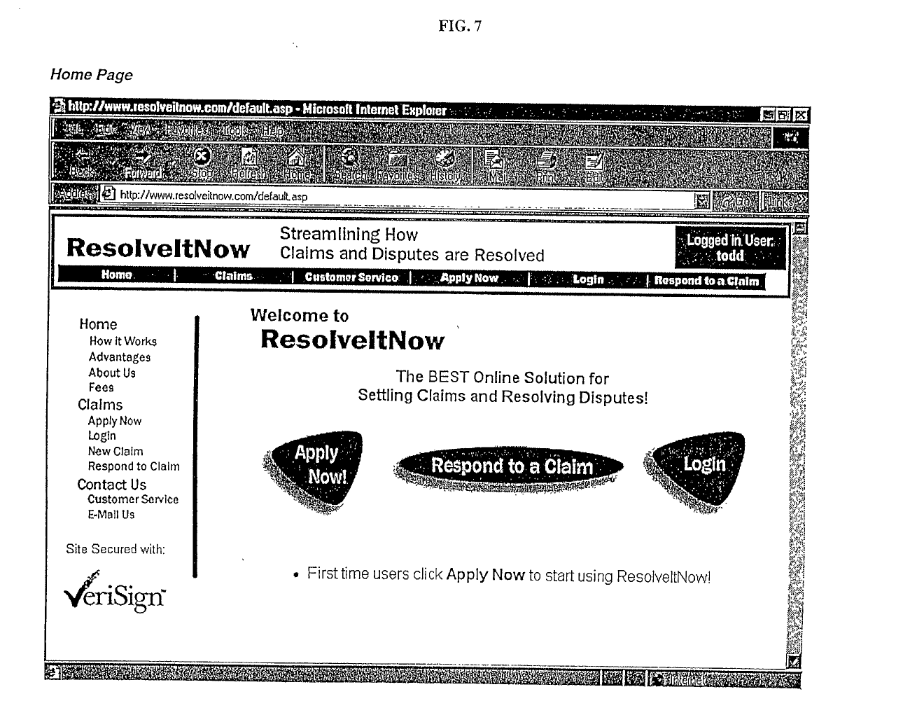

Using browser 420, the initiating party views the web site that displays a menu of the services provided by the system. FIG. 6 is a flow diagram of the available menu items, according to one or more embodiments of the system. In one embodiment, an initiating party is provided with various choices upon arriving at the system's home page. Typically, a home page is the first page that is displayed to a person who wishes to utilize the contents or the services of a web site. FIG. 7 is an example of a home page displayed by the system. For example, once a party views the system's home page, he is provided with choices to contact a service provider's representative, access a discussion forum or a series of informational pages describing the fees, advantages, and nature of services provided by the system.

Referring to FIGS. 6 and 7, at step 610, a party may use a pointing device or other user interface devices to select a menu item (e.g., Contact Us) to contact the service provider, for example. Once the menu item is selected, contact information including email address, business hours, phone numbers, and other relevant information are displayed on client computer 410. Alternatively, a party may select another menu item (e.g., Customer Service) at step 612. Once that menu item is selected the system displays information relevant to that menu item (e.g., customer service information including emergency contact information).

In some embodiment, at step 613, a party can select a menu item that allows the party to forward an email to the service provider. Once that menu item is selected the system provides a pop-up email window addressed to the service provider, for example. Using this feature a party may electronically correspond with the service provider.

In some embodiments, a communication forum in form of a public or a private exchange is provided. The communication forum can be in the form of a bulletin board where a party can post certain information to be viewed by others. Another type of communication forum is referred to as a chat room where many parties can join and interactively communicate on line. A public communication forum is typically accessible by a large number of people, while a private forum is limited to certain people only.

Thus, for example, at step 614 a party selects a menu item that allows him to exchange information in a communication forum. The party is provided with a web page that includes references to public and private bulletin boards or chat rooms. For example, the party can select a public forum or he may choose a private communication forum. In certain embodiments, in order to access a private forum a party enters a user ID and a password. Once at one of these forums, a party can communicate with others about the value of a case, for example, or communicate with adverse parties over the resolution of a matter.

Other examples of menu options available to a party according to one or more embodiments are illustrated in FIGS. 6 and 7. For example, in steps 620 through 626, a party may choose from menu options that display information about how the system works, the advantages of the system, biographies of personnel responsible for the development of the system, and fees associated with use of the system. In certain embodiments, for example, each party has to pay a flat (e.g., $150) fee if the dispute is resolved using the system.

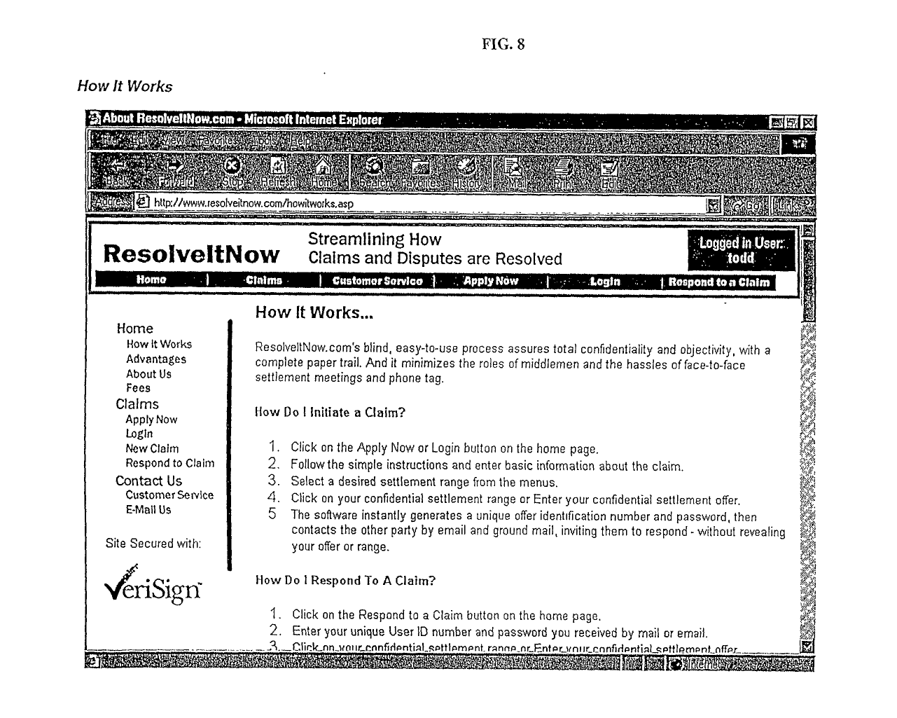

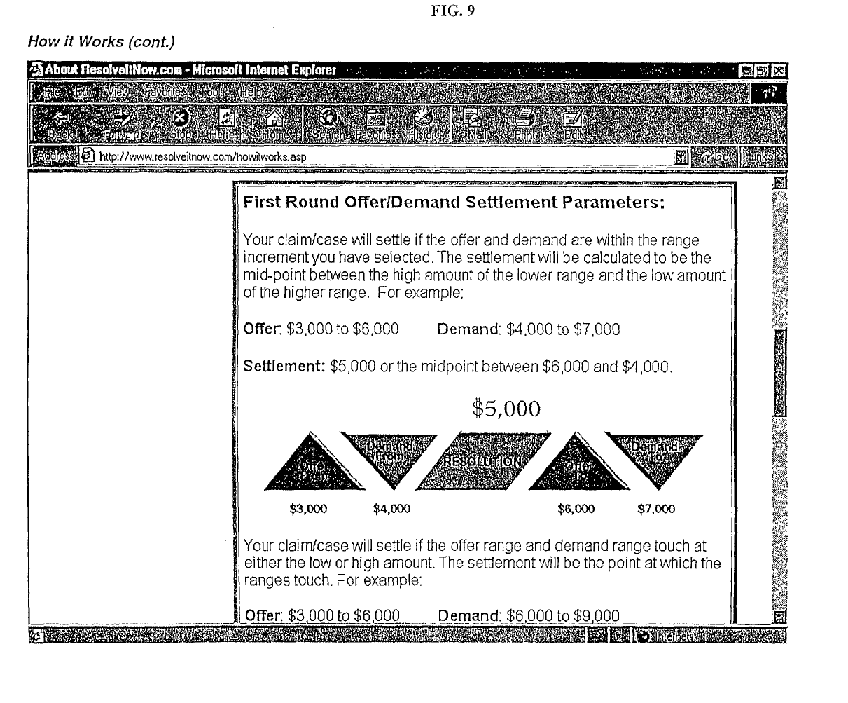

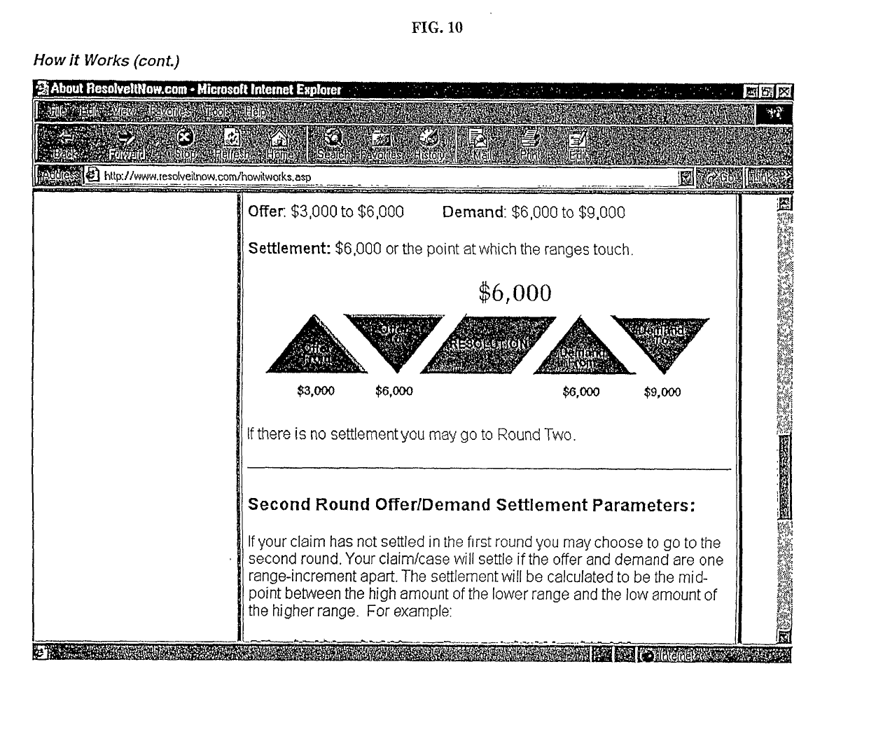

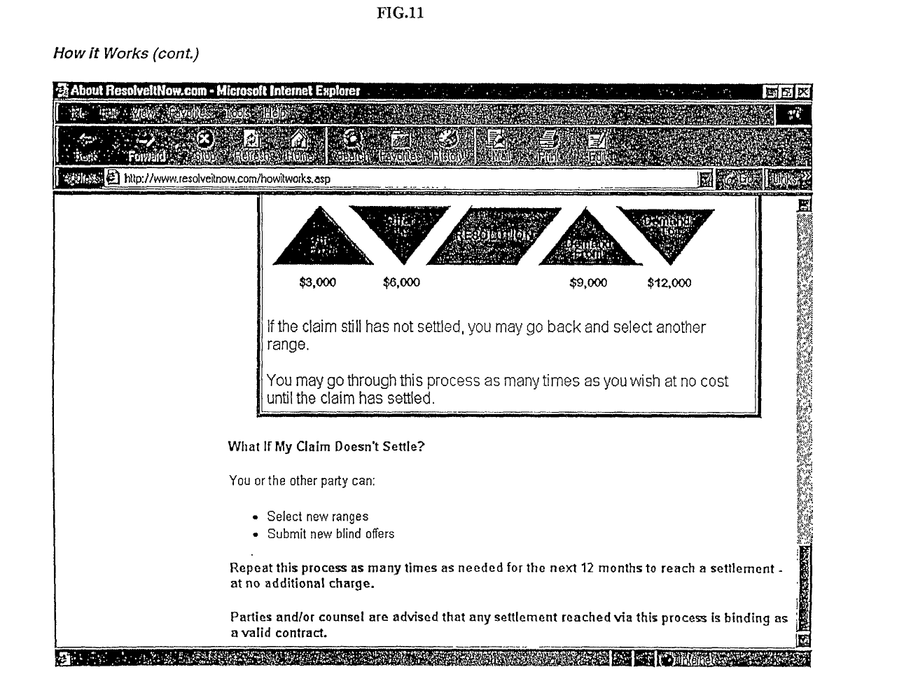

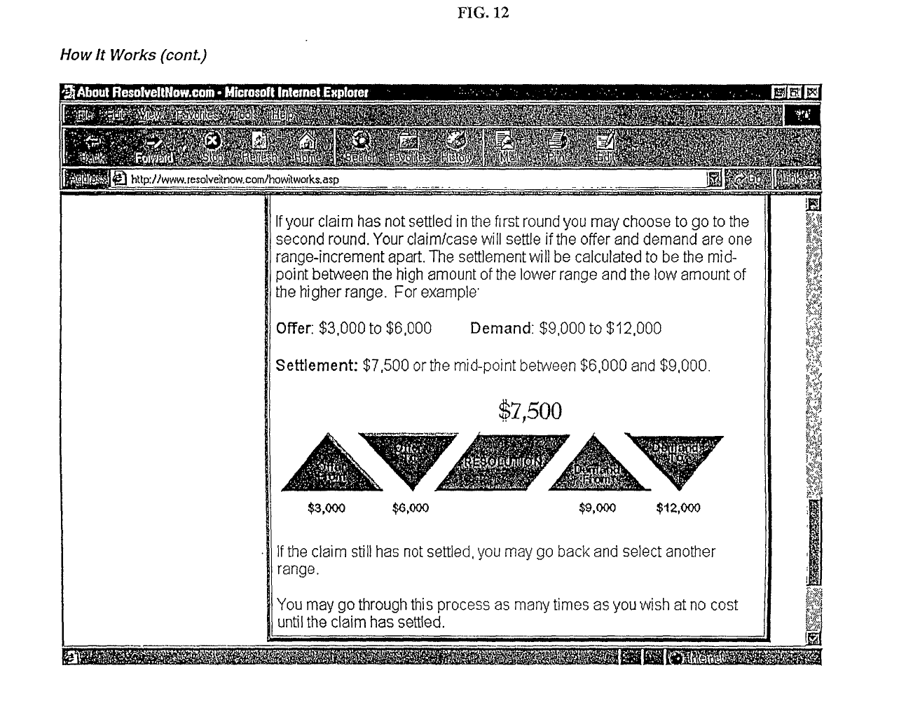

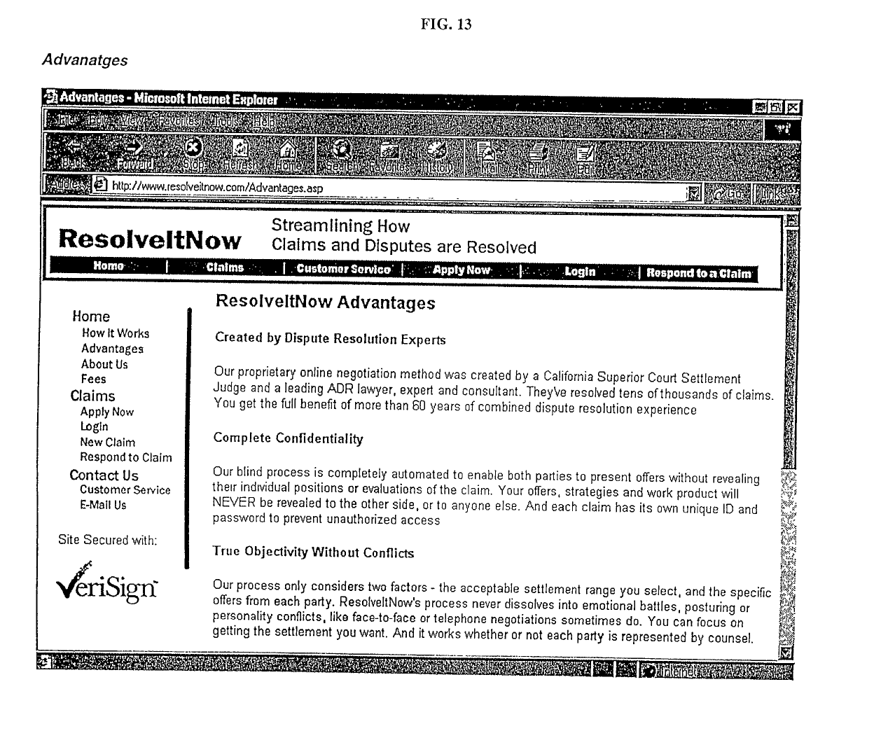

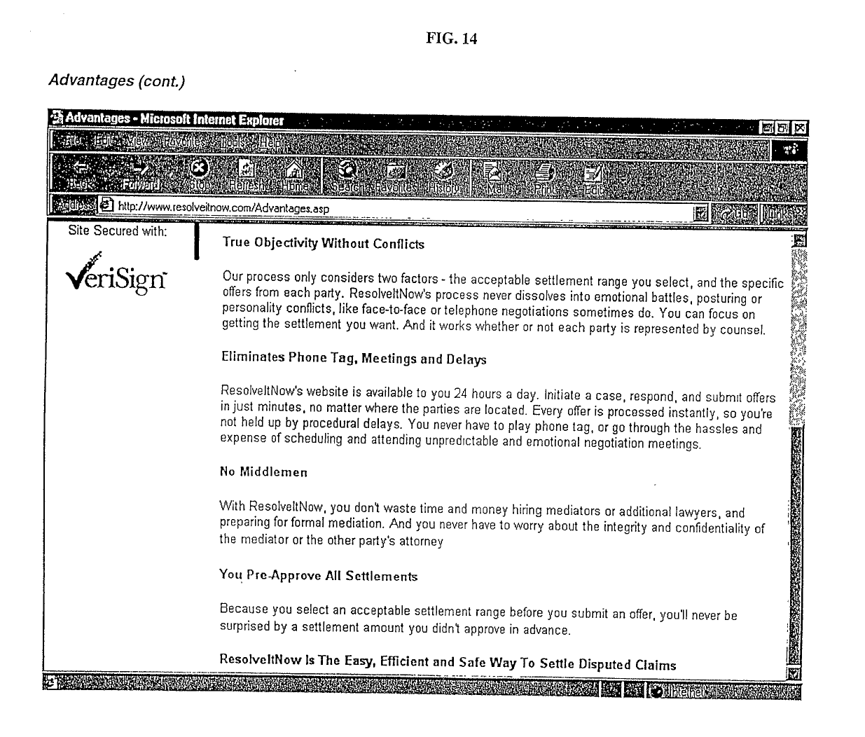

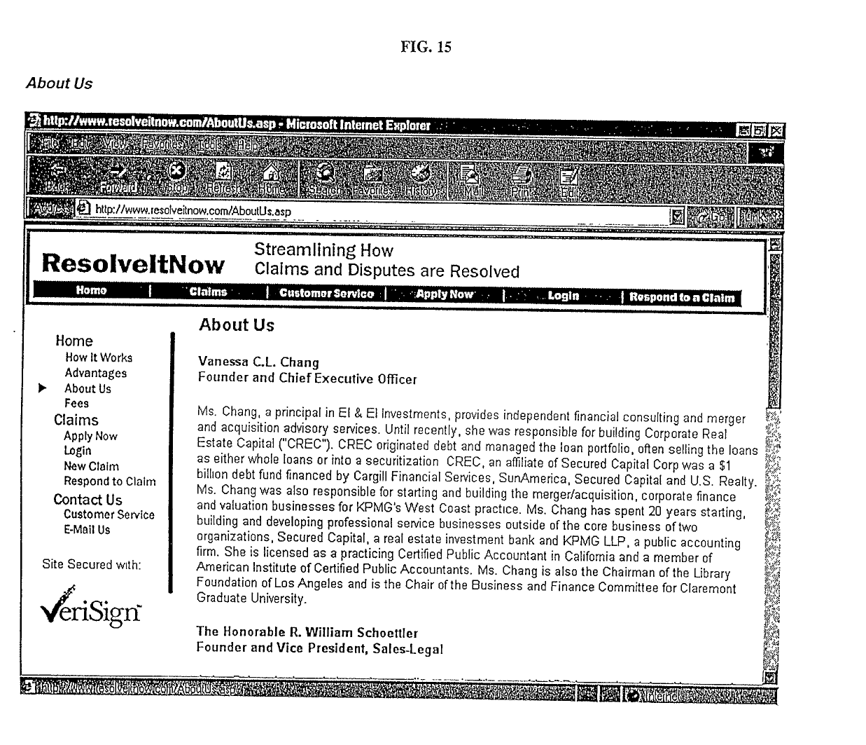

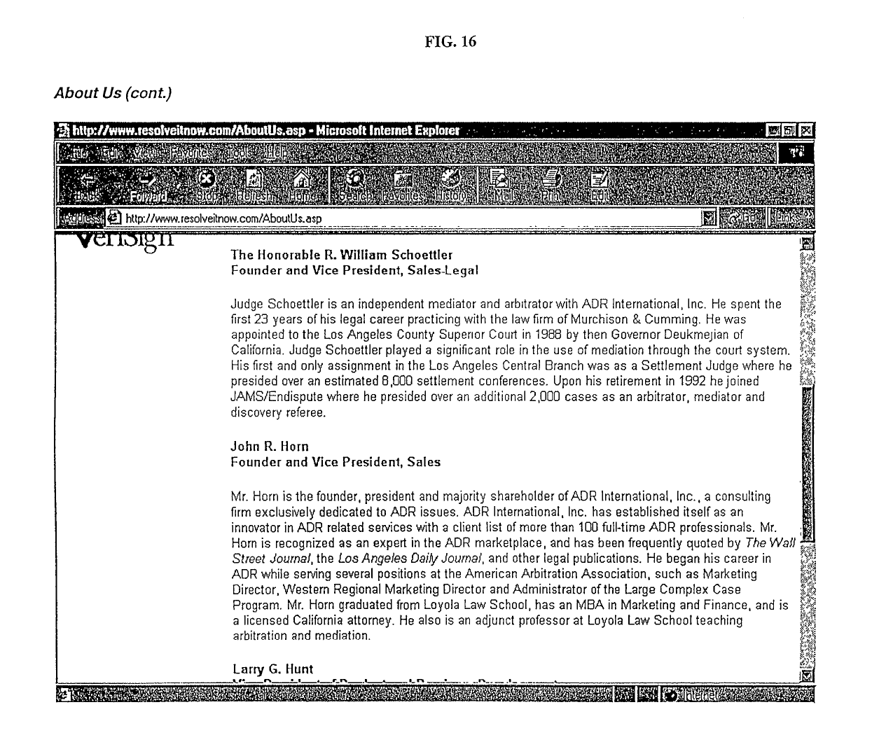

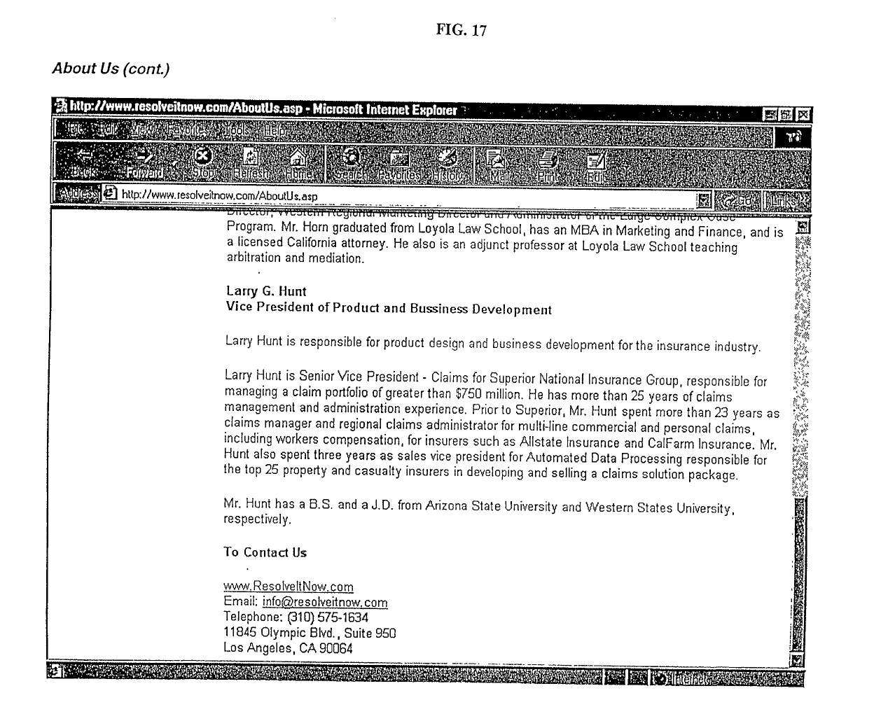

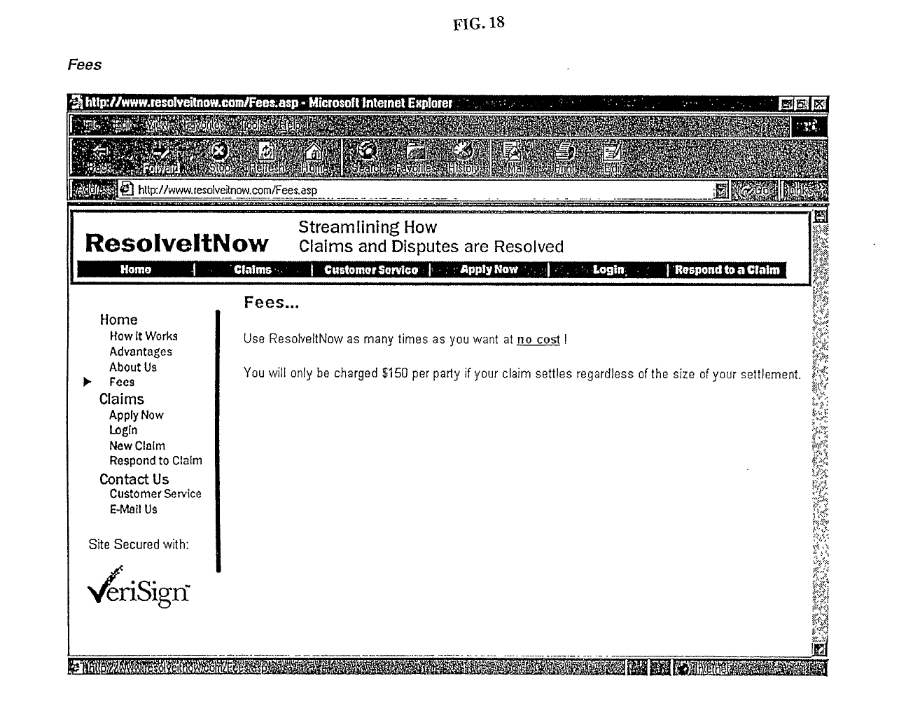

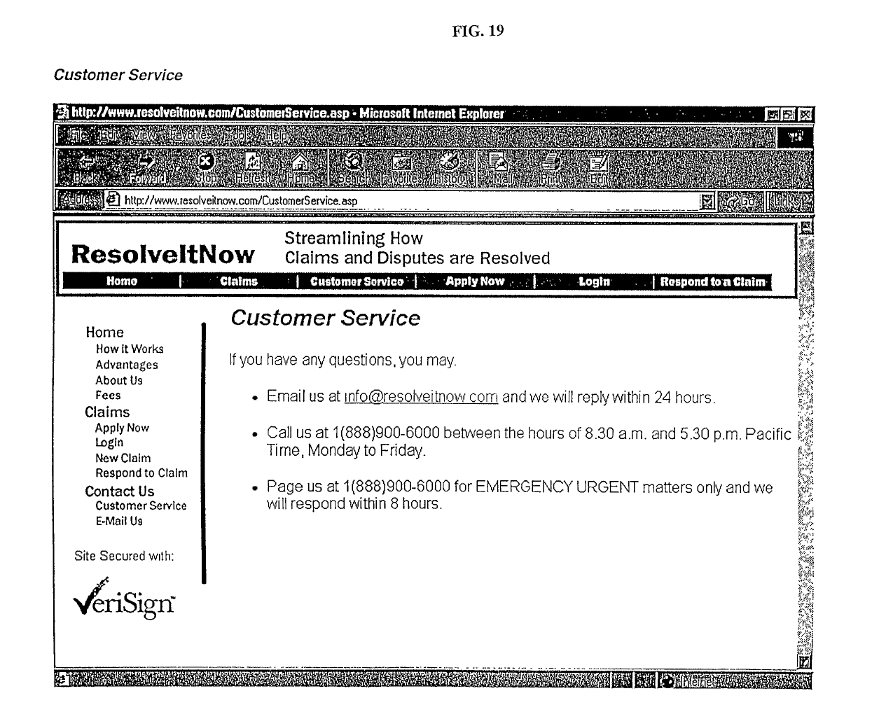

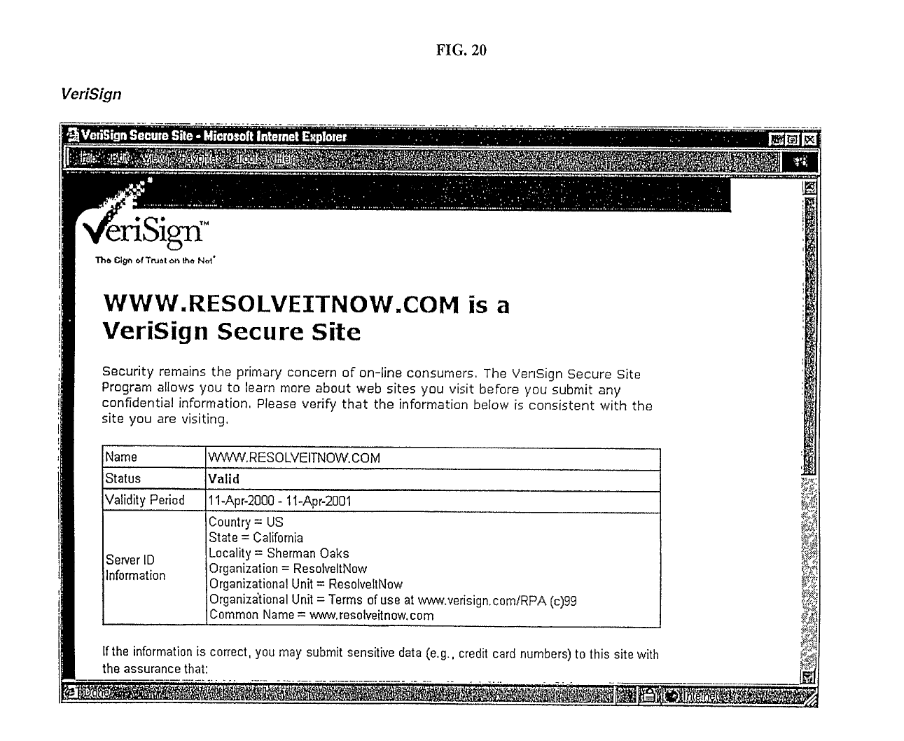

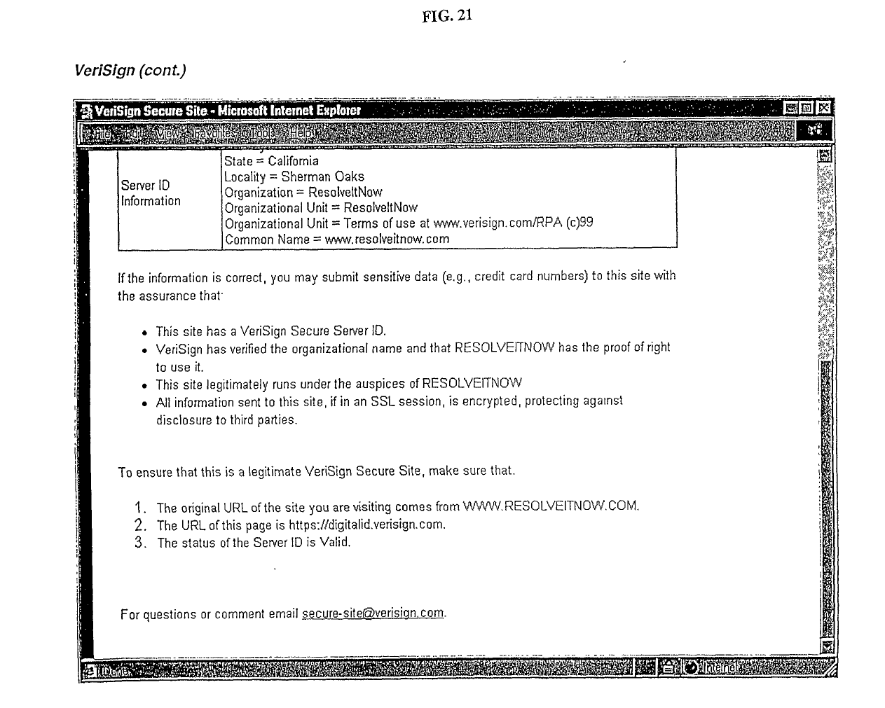

FIGS. 8 through 12 are examples of web pages, according to one or more embodiments of the system, that contain information about the manner in which the system works. FIGS. 13 and 14 are examples of web pages, according to one or more embodiments of the system, that contain information about advantages of the system. FIGS. 15 through 17 are examples of web pages, according to one or more embodiments of the system, that contain information about the founders of the system. FIGS. 18 through 21 are examples of web pages, according to one or more embodiments of the system, that contain information about the fees, customer service, and security features of the system.

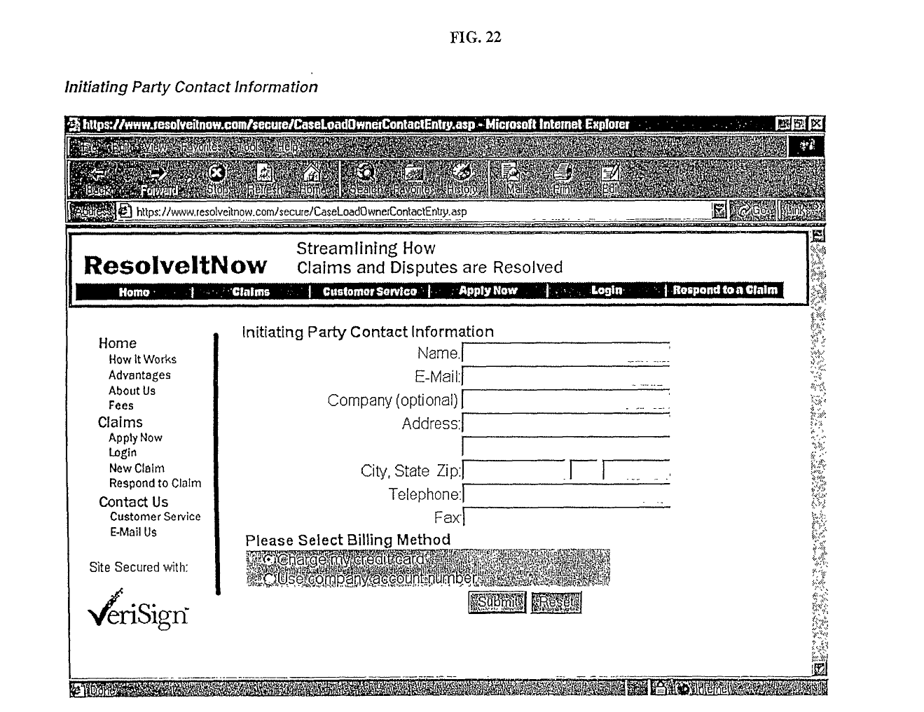

Referring back to FIG. 6, in certain embodiments, a party is provided with the choice to apply to register and subscribe to the services provided by the system, to initiate, view, respond to claims, or to login to the system. For example, in one embodiment, at step 630 a party applies to the service provider to become a registered client. Once a party chooses to subscribe, the system prompts the user to enter his or her information, by displaying the web page illustrated in FIG. 22, for example. Then, the party provides his or her contact information including his name, email address, company information, and other information requested by the system. This information is used for tracking purposes and to bill the user in the event a matter settles.

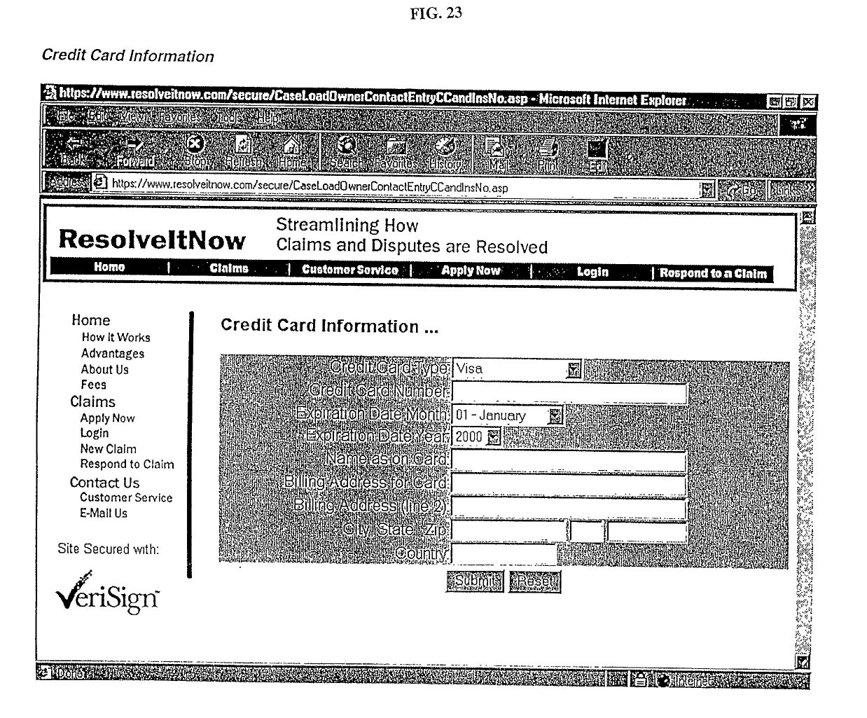

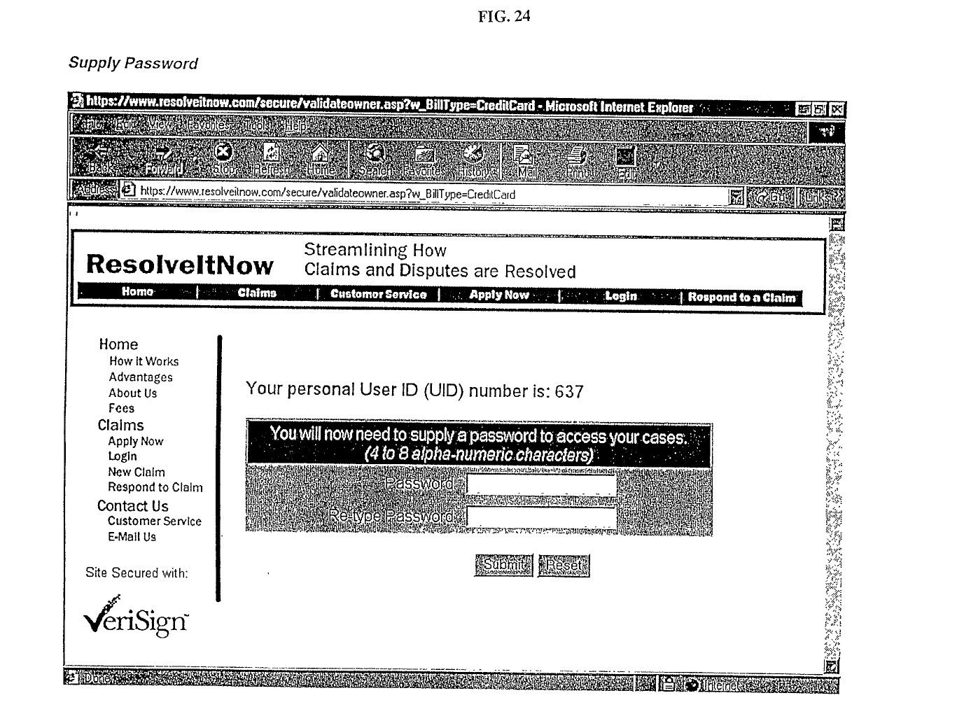

As shown in FIG. 22, once the requested information are provided, the party has the option of choosing between one or more billing methods (e.g., credit card, company account). If the party selects to pay by credit card then the system displays a web page such as that illustrated in FIG. 23, for example. The party then enters the required credit card information. The system then prompts the party to provide a confidential password. When the party supplies the password the system provides a user ID to the party, as illustrated in FIG. 24.

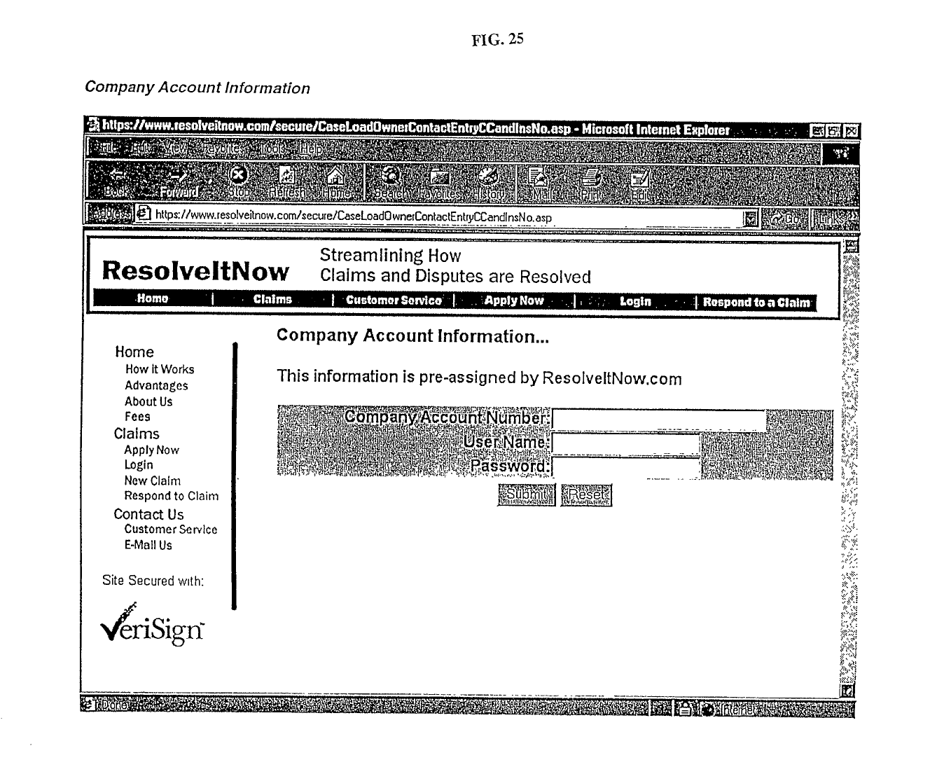

Alternatively, if a party wishes to set up a company account, instead of credit card information he is prompted to provide information for setting up a company account. FIG. 25 illustrates an example of a web page, according to one or more embodiments of the invention, wherein a party can enter company information into the system. The information entered by the party are analyzed by the system to determine the financial authorization level of the initiating party and other particulars related to the company's power structure. For example, in certain embodiments, a company employee (e.g., an insurance adjuster) may have a certain level of authority (e.g., below $25,000) to settle a claim. As such, based on such limitation, the system customizes certain system functions to prevent that employee from acting above and beyond his or her authority. Certain embodiments of the system allow a claim to be co-administered by two or more company employees.

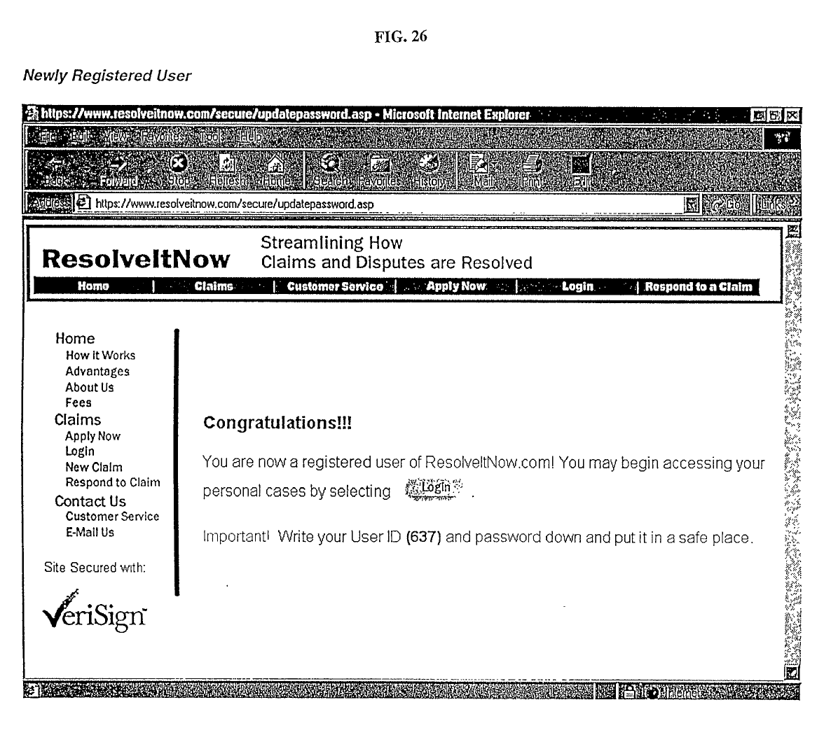

Once the needed information is provided by the party, the system provides company account information (e.g., account number, password). In certain embodiments, the registering party can select his or her personal ID or password. Afterwards, the party is notified that he has completed the registration process and the system displays a web page such as that displayed in FIG. 26, for example, congratulating the registering party for successfully completing registration. Once a party has registered, he or she can access the services provided by the system by logging into the system.

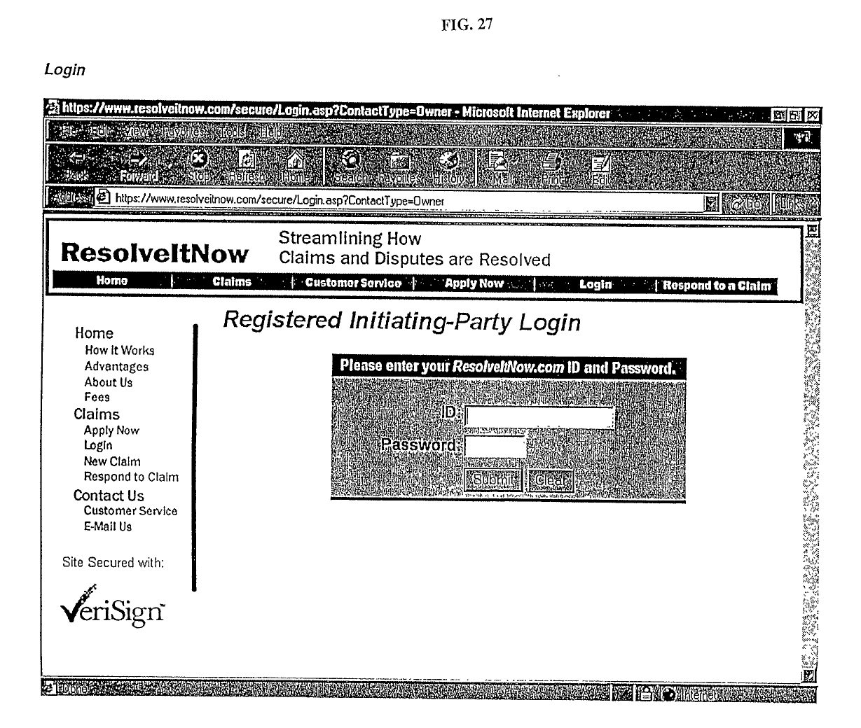

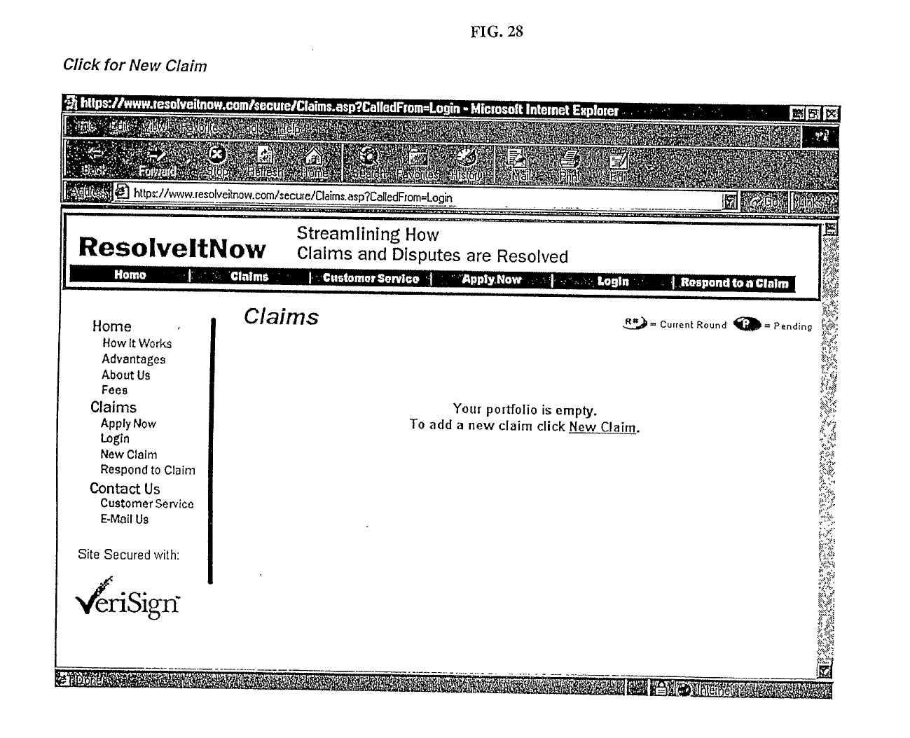

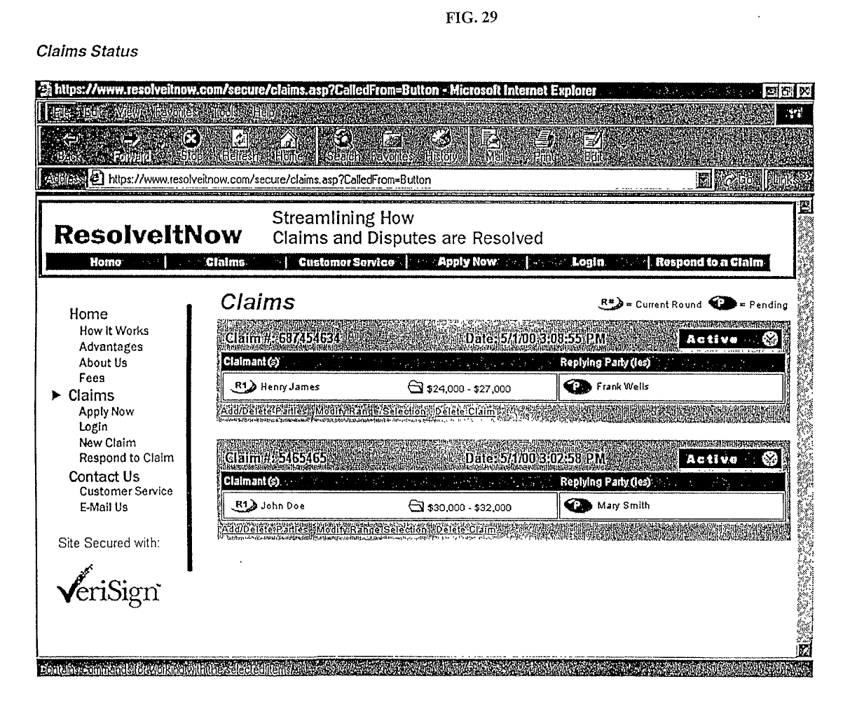

FIG. 27 illustrates an example of a web page displayed to a party who wishes to login to the system, according to one or more embodiments. Referring to FIG. 27, a party is prompted to provide an identification number and a password in order to login. Once the party enters a user ID and a password, if the party is a first time user, then a web page such as the web page illustrated in FIG. 28 is displayed indicating that no claims are pending for that specific user. Otherwise, a web page such as the web page illustrated in FIG. 29 is displayed, providing the user with information on pending claims and the status of each claim. For example, information about the parties involved in each claim, the claim number, and the amount of any offers or demands are provided.

In certain embodiments of the invention, settlement offers remain confidential; thus adverse parties are unaware of the settlement amount offered by the other party. As illustrated in FIG. 29, the user is given the option to add or delete parties involved, modify the settlement offer, and to add or delete claims. Some embodiments provide a user with information about the status of negotiations by providing visual or other types of indicators. For example, as illustrated in FIG. 29, a symbol (e.g., R1) can indicate that a party has entered into a first round of negotiations by submitting a demand or an offer. Another indicator symbol (e.g., P) can be used to inform a party that the adverse party has not yet responded to his offer of settlement and that the initial offer is pending, for example.

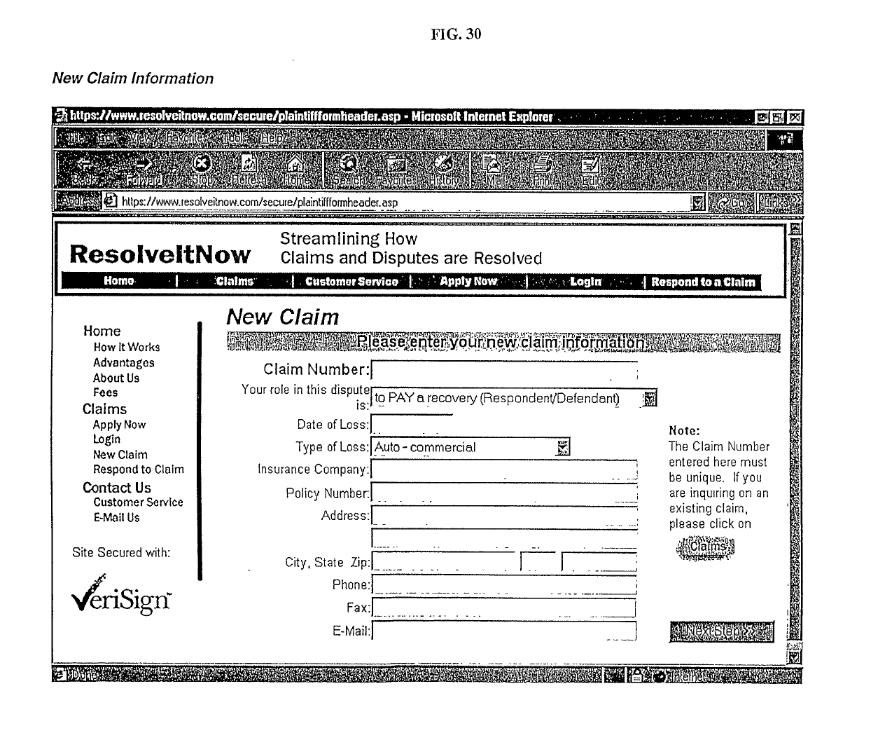

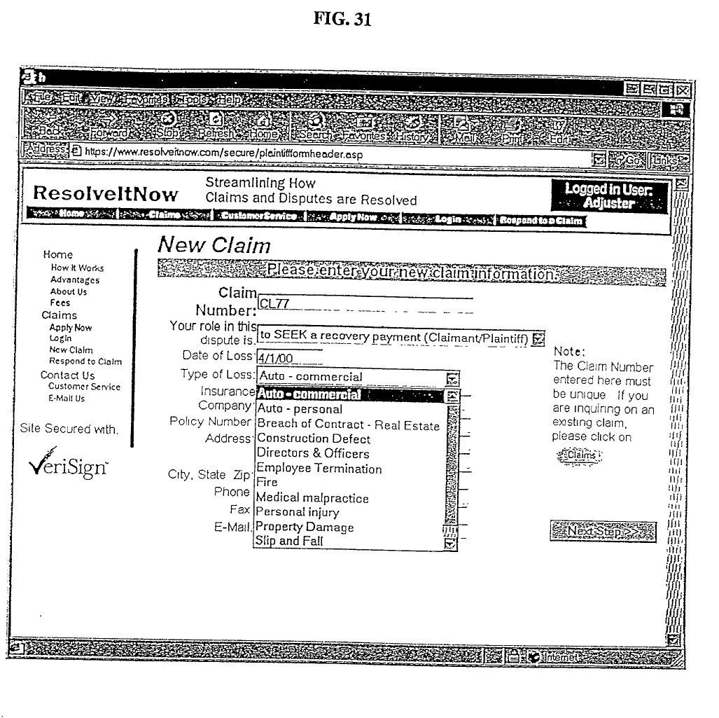

Referring back to FIG. 28, in case of a new user, the user is prompted to set up a new claim if his claim portfolio is empty. To set up a new claim, the system displays a web page such as the web page illustrated in FIG. 30, for example, prompting the user to provide information for initiating a new claim. As illustrated in FIG. 31, the user may select from various types of loss (e.g., auto, breach of contract, medical malpractice, personal injury). In embodiments of the invention, depending on type of loss selected a user may be prompted to provide more information. For example, if the type of loss involves workers compensation, the system will require the entry of additional information including the state in which the injury occurred, category of loss, and other legally related particulars.

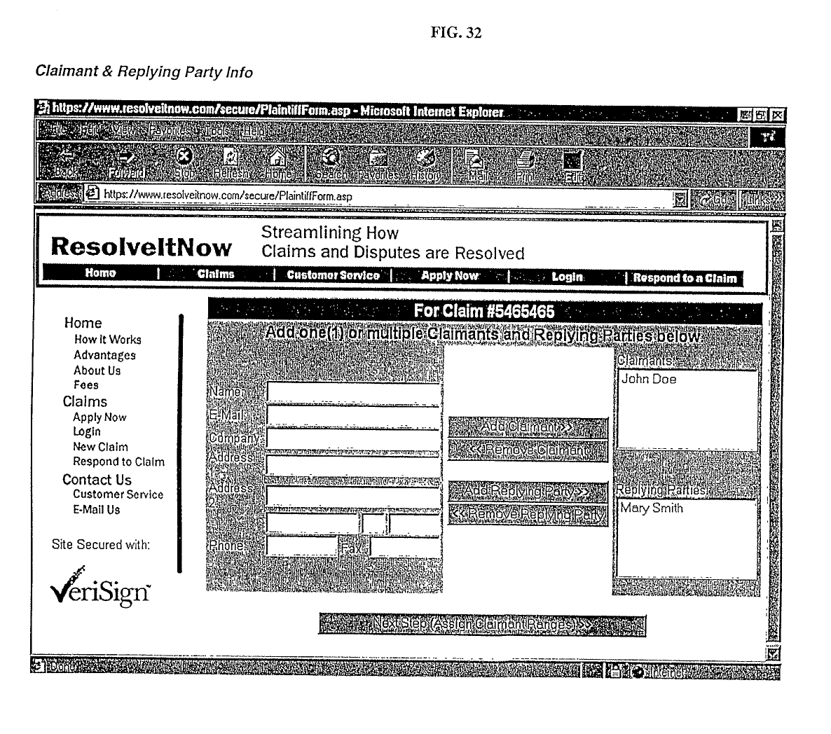

In certain embodiments, the user is prompted to add information about the parties involved. As illustrated in FIG. 32, information about claimants, respondent, and their relevant contact information may be added or removed by clicking on a graphically displayed button, for example. Embodiments of the invention are implemented to handle multiparty disputes. Detailed information relating to a claim, including claim number, party positions (claimant/respondent), date of loss, type of loss, insurance company, policy number, and contact information are solicited by the system, in one or more embodiments. User interfaces are used to assist the user to choose between various items. Collected information is used by the system to track the individual claim, notify other parties of the initiation of a claim, and provide demographic data and profile information for tracking trends in dispute resolution.

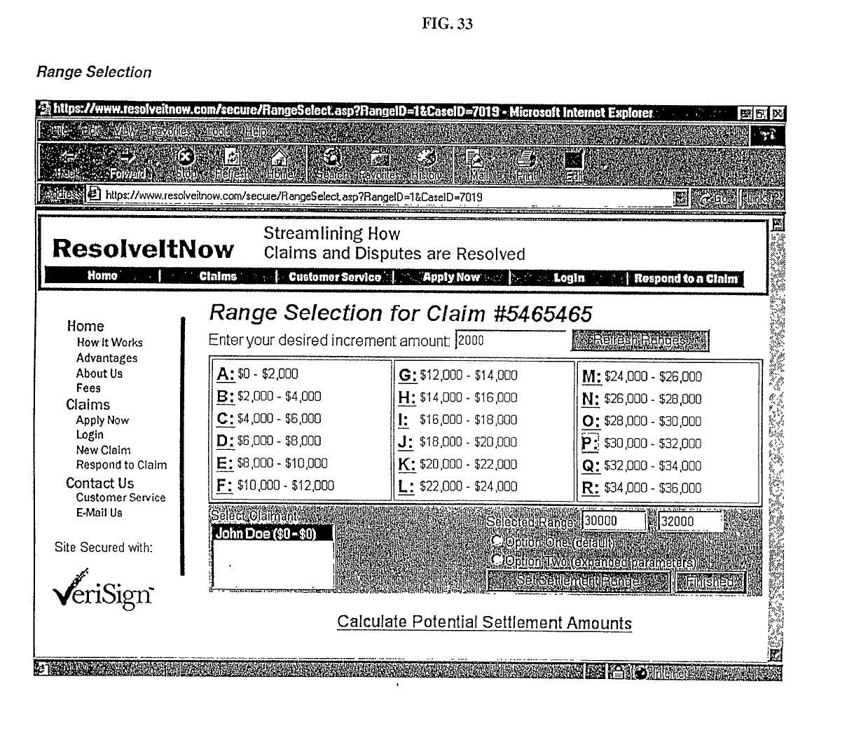

After a user has completed entry of information for his or her side of the dispute, the user is then prompted by the system to provide contact information for the other party. The system uses the contact information for the other party to invite the other party to participate in the dispute resolution process. The system may invite the other party to participate via various forms of correspondence (e.g., mail, fax, e-mail). After the user has provided the party information, the system records the provided party information and sets up a claim for the dispute. The user can then initiate a settlement offer that includes the minimum and maximum limits for which the user is willing to settle the claim. FIG. 33 illustrates an example of a web page, according to one or more embodiments, where a user can select a settlement range from a menu of various settlement ranges.

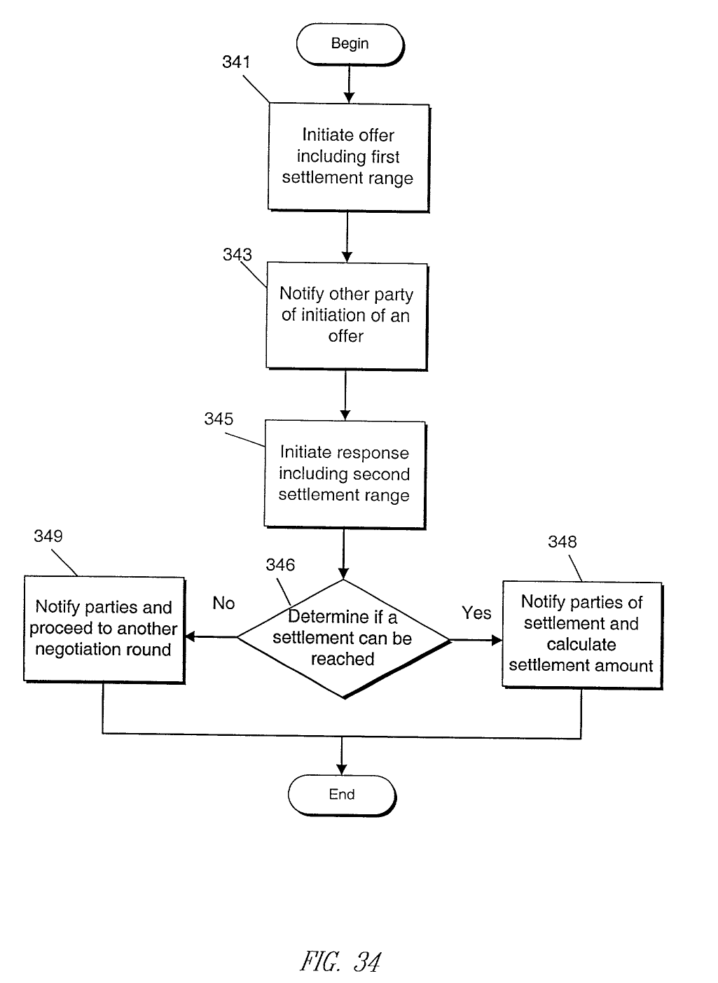

Referring to FIGS. 33 and 34, an initiating party utilizing one or more embodiments of the system initiates an offer to settle a claim, at step 341 by selecting a settlement range. A settlement range according to one or more embodiments maybe either directly entered (e.g., by entering a maximum and a minimum value into a provided text box) or my alternatively be selected from a menu of ranges generated by the system, where the generated ranges differ by a predetermined increment, for example. In some embodiments, the increment is selected by the user.

As illustrated in FIG. 33, to generate a menu of ranges an initiating party enters an increment amount (e.g., $2,000) and clicks on a refresh button, for example. The system then automatically displays multiple ranges based on the increment value entered. The user then can select a settlement range that best reflects the settlement value of the case. For example, as it is illustrated in FIG. 33, a user may select settlement range $30,000 to $32,000 by clicking on letter “P. Alternatively, in certain embodiments, a user can choose to override the range feature of the system by entering an exact range (e.g. $30,521 to $30,562). If the user prefers to make an offer to settle a case at an exact amount (e.g., $30,000), then he or she can enter a range that includes that amount only (e.g., $30,000 to $30,000).

In some embodiments, the initiating party may select between two available options. If the first option is selected then the settlement range is the range selected by the user. However, if the second option is selected the settlement range is expanded based on a certain percentage of the difference between the highest and lowest amounts in the range selected by the user. Thus, for example, if the user selects the range $30,000 to $32,000 under the first option, then the settlement range will remain intact as originally entered. However, if the user selects the same range under option 2, then the settlement range is expanded to a different value depending on the expansion percentage calculated. For example, if the system is implemented to expand the chosen range by 50% of the increment value then, in the above example, the final settlement range will be $29,000 to $33,000, as 50% of the settlement range (e.g., $2,000) is $1,000. In one or more embodiments, option 2 is not available to a user that is making a first attempt to settle a claim.

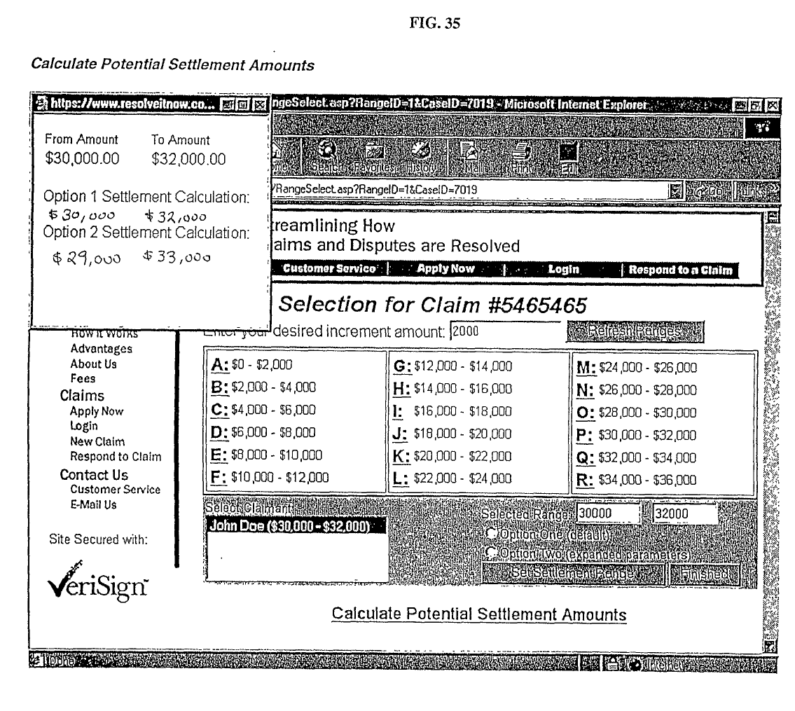

In some embodiments, once a range has been selected the user has an option of using a system feature that provides the users with the range of potential settlement amounts based upon the range and option selected. FIG. 35 is an example of a web page, illustrating this feature. For example, presuming that the expansion rate is 50%, then upon activation of the feature, the system displays the range of $30,000 to $32,000 as the potential settlement amount under option 1, and the range of $29,000 to $33,000 as the potential settlement amount under option 2.

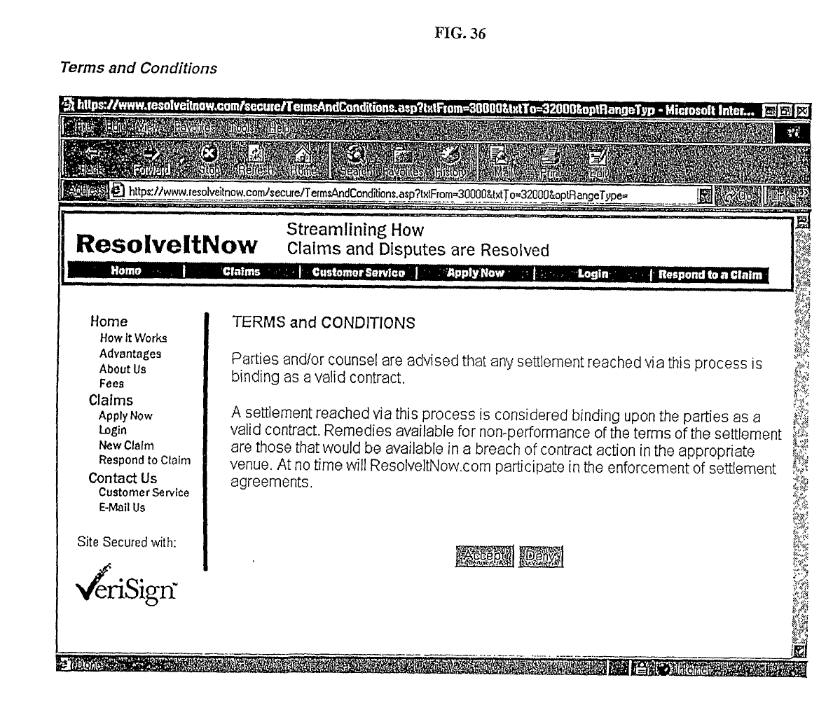

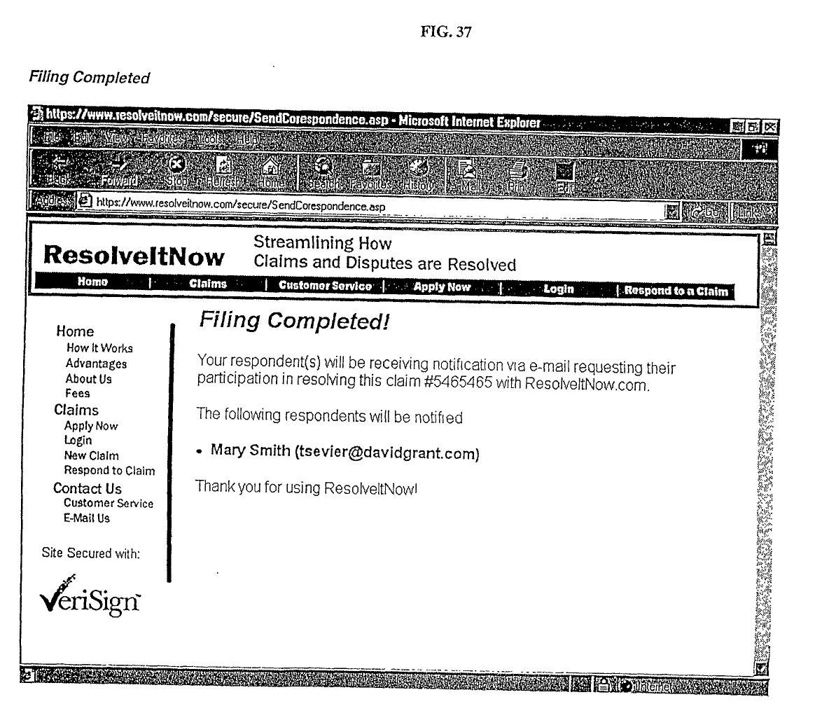

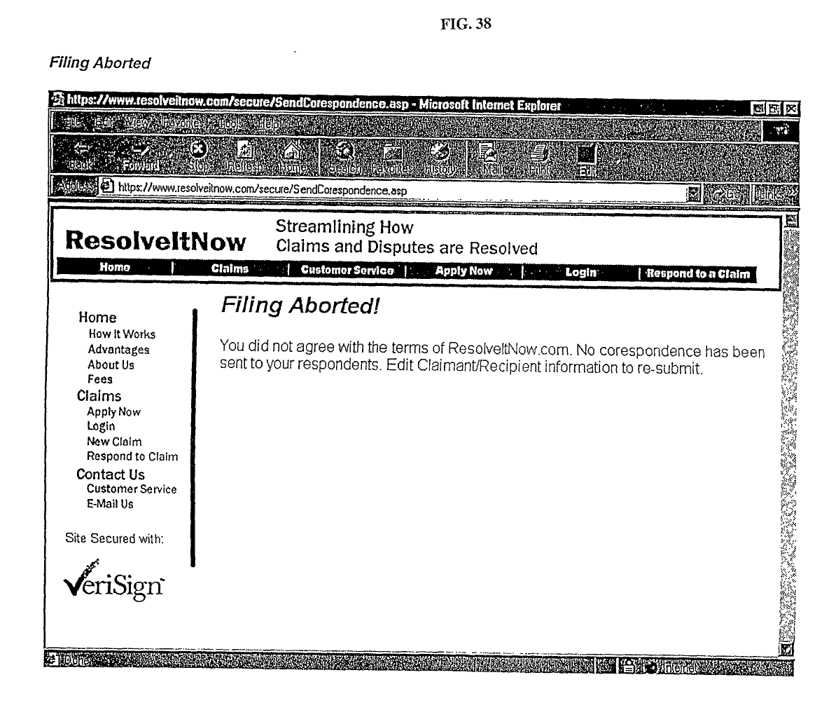

After the user has selected the settlement range, the system displays a web page such as the web page illustrated in FIG. 36 containing the terms and conditions of the process. The parties are advised that any settlement reached as a result of the process is binding as a valid contract. If the user accepts these terms (e.g., by clicking on the accept button), the system displays another web page such as the web page illustrated in FIG. 37, for example, confirming completion of the filing of the claim. The system also lists the parties that will be invited to the process. If the user denies the displayed terms, the filing of the claim is aborted and a web page such as that illustrated in FIG. 38 is displayed to the user, for example.

The selected settlement range and other information provided by the initiating party are stored by the system. Referring to FIG. 34, at step 343, the opposing parties in the dispute are notified of the initiation of the claim. The system generates automatic notifications in written or electronic form and forwards them to parties involved, inviting them to respond. In certain embodiments, the settlement amount entered by the initiating party is not revealed to the other party. After the proper parties are notified, the system then waits for a response from the parties.

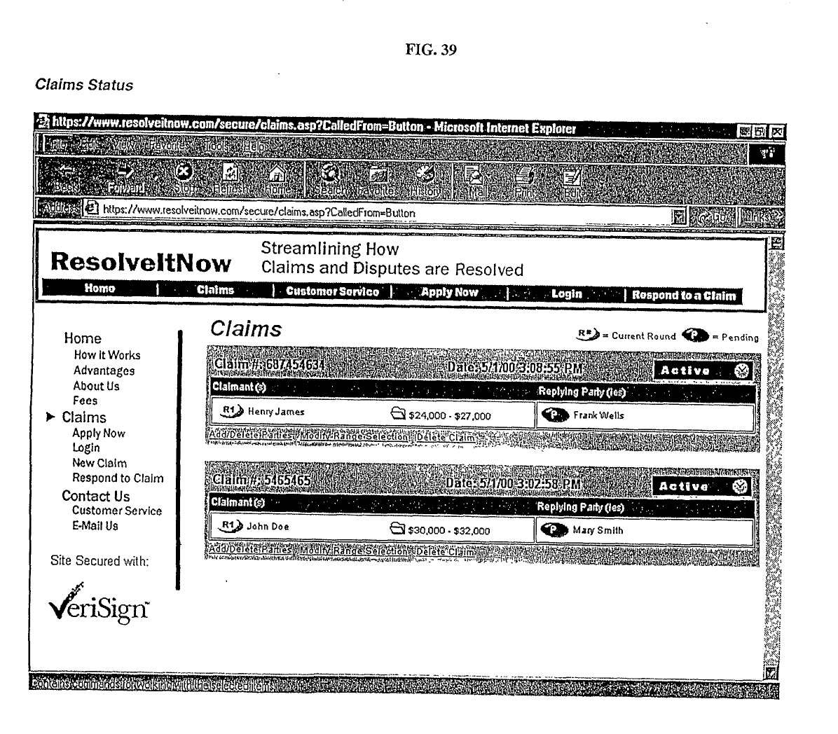

The initiating party, in some embodiments, may modify or withdraw the settlement offer at any time, unless the other party has responded. To modify claim information, a user can log into the system and enter his or her identification and password. As illustrated in FIG. 39, the system provides the party with a portfolio of all claims handled by the user and the status of each claim. The user can then use the appropriate features of the system to modify claim information. For example, a user can add or delete additional claimants and respondents, or modify pending settlement offers.

In certain embodiments, a deadline is associated with the time a party has to respond to an offer of settlement. For example, if no response is received within 30 days of the initiation of the claim, the initial offer is automatically withdrawn. Embodiments of the system are implemented to notify one or more parties of the deadline in advance, reminding them to reply. In one or more embodiments, the system gives the initiating party the opportunity to extend the deadline, if he wishes. Regardless of the number of times a deadline is extended, the system assigns an absolute deadline (e.g., one year) for a dispute to be resolved. Otherwise the related claim is removed from the system.

Referring to FIG. 34, once notified of the initiation of a claim, a responding party at step 345 offers a settlement response. In certain embodiments, the responding party logs into the system and thereafter selects the menu option that allows him or her to respond to a claim. The system then prompts the responding party to provide a reference number for a particular dispute or claim. This number, in some embodiments, is automatically assigned by the system to a claim at the time of initiation and is included in the correspondence inviting the responding party to participate.

Once the responding party provides the reference number, the system displays the relevant information to the claim associated with the reference number. This information can, for example, include the name of the initiating party, claim number, date of loss, type of loss, and date of initiation of the claim with the system. In embodiments of the invention, the responding party is asked to provide certain information including credit card or account information for payment in the event of a settlement.

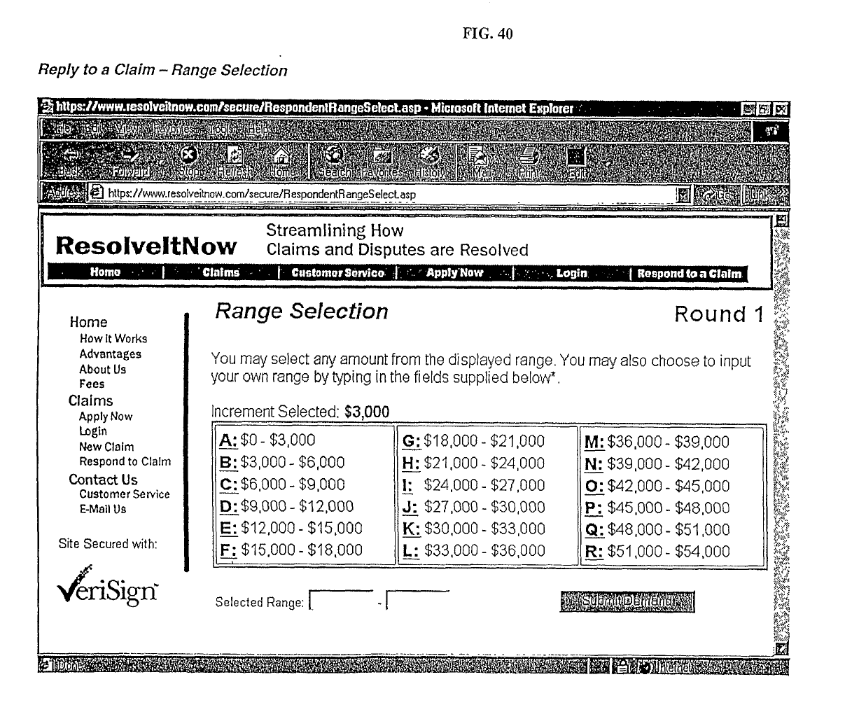

The system then prompts the responding party to enter a settlement amount, for example, by displaying a web page such as that illustrated in FIG. 40. At this point, the responding party has the opportunity to select a settlement range or enter an exact settlement amount. In embodiments of the system, the responding party is provided with a menu of settlement ranges that was generated by the initiating party without knowing that the initiating party has selected the increments. The responding party has the option of choosing a range from the menu. Certain embodiments of the system allow the responding party to overwrite the menu choices by entering a new range. Once the settlement range is selected, the responding party can use the system feature that displays possible settlement values. For example, depending on the status of the claim, the responding party may have the option to expand a settlement range by a certain percentage of the increments between the highest and the lowest settlement amount, as described earlier.

After entering the settlement amount, the responding party confirms his selection, by clicking on a submit button as illustrated in FIG. 40, for example. Thereafter, the system displays the terms and conditions of the settlement and advises the responding party of the binding nature of the process. If the responding party confirms then his settlement offer or range is forwarded to the system for processing, at step 346. The details of the method used by the system to process settlement offers provided by the parties is described below.

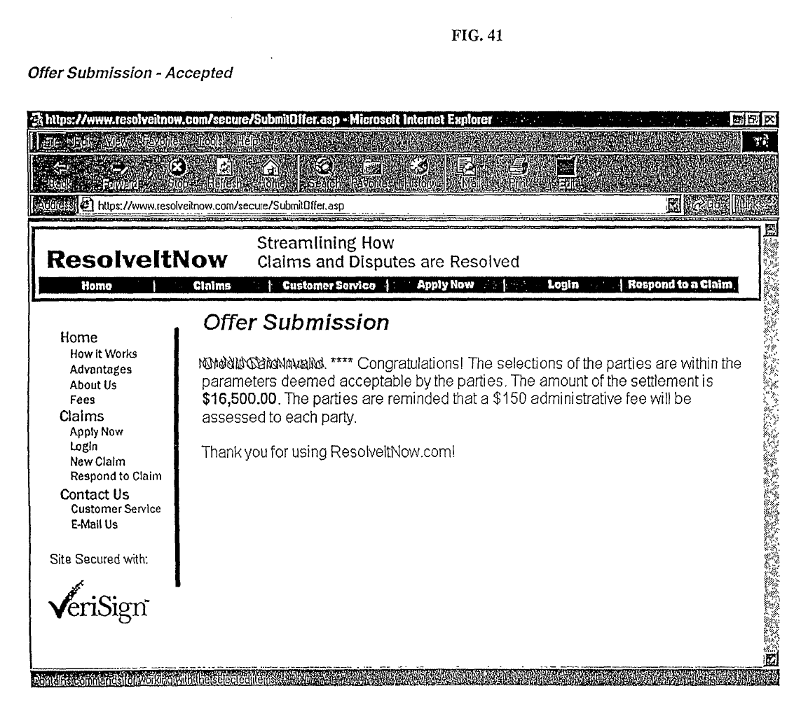

If the system after processing the submitted settlement offer determines that a settlement has been reached, then the parties are notified and a settlement amount is calculated, at step 348. In certain embodiments, a party who has submitted a settlement offer, in response to an invitation to resolve a dispute, is notified almost immediately by a pop-up window, for example, that announces the settlement and the amount of the settlement. FIG. 41 illustrates an example of a web page displayed when a settlement is reached. The other party is also notified in written, electronic, or other communication means of the settlement.

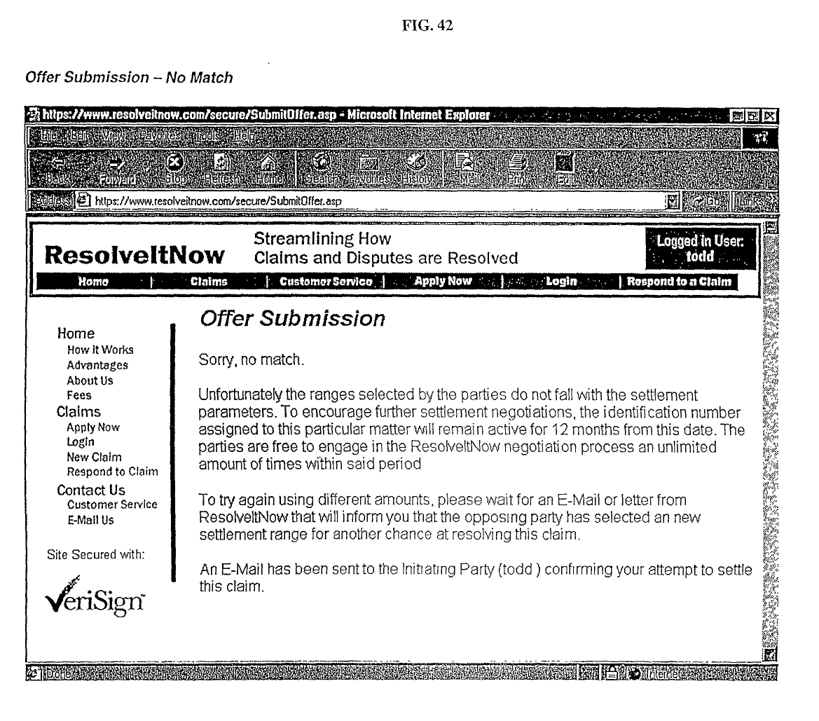

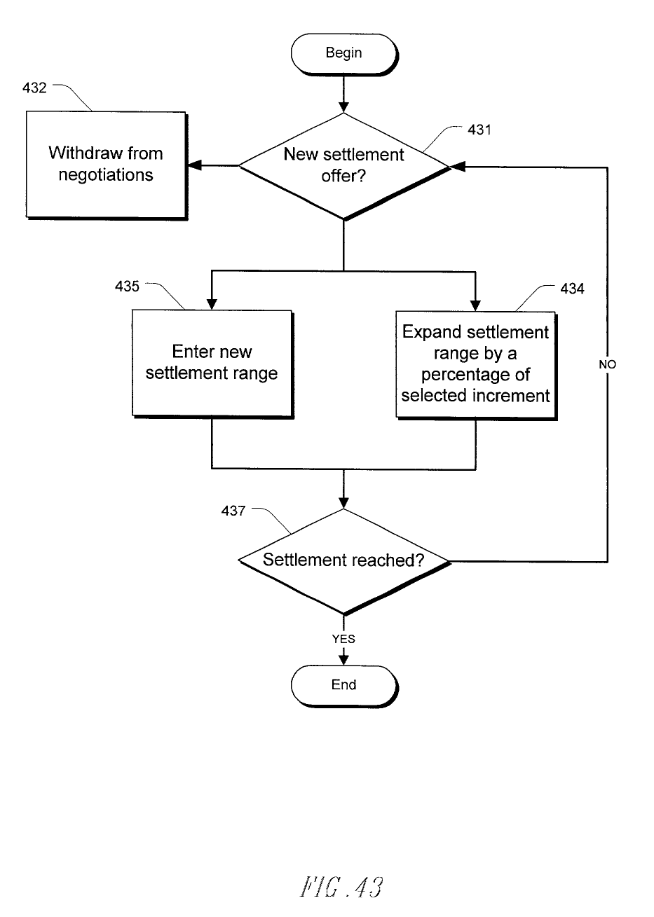

If the system after processing the submitted settlement offers determines that a settlement is not reached, then at step 349 the system notifies the responding party, for example, by displaying a web page such as that illustrated in FIG. 42 that no settlement has been reached and offers the responding party to proceed to another negotiation round. In some embodiments, the responding party is precluded from proceeding to another negotiation round and submitting another settlement offer until after the other party has had an opportunity to proceed to another round of negotiation first. The system updates its records to indicate that the responding party has responded but that no settlement has been reached. For example, in an embodiment, the system displays a status indicator showing that a first round of negotiations has been completed. In new negotiation rounds, parties can start the process over by either offering new settlement ranges or by expanding the previous settlement ranges as it is illustrated in FIG. 43.

FIG. 43 is a flow diagram illustrating options available to the parties if a settlement is not reached during a negotiation round, according to one or more embodiments of the system. At step 431, a party is provided with the choice to initiate a new settlement offer. If the party does not wish to proceed with a new round of negotiations then at step 432 the party withdraws form negotiations. The system, in one or more embodiments, then notifies the other parties. The initiating party has the option of removing the claim from the system.

If the party wishes to continue, the system proceeds to steps 434 or 435, where the party has the option of either expanding the previously offered settlement range or entering a new settlement range altogether. As described earlier, the system can automatically calculate and extend a settlement range, by a percentage of the difference between the minimum and maximum values in that range. Once the new settlement range is selected and submitted to the system, at step 437, the system determines if a settlement can be reached based on the new settlement offer. To determine whether a settlement has been reached, the system uses a predefined logic to compare the ranges selected based on certain parameters, for example. The logic used to determine the settlement amount is implemented such that the system determines a settlement amount based on the upper and lower limits of settlement ranges provided by each party. If a settlement is not reached, then in some embodiments the system reverts back to step 431.

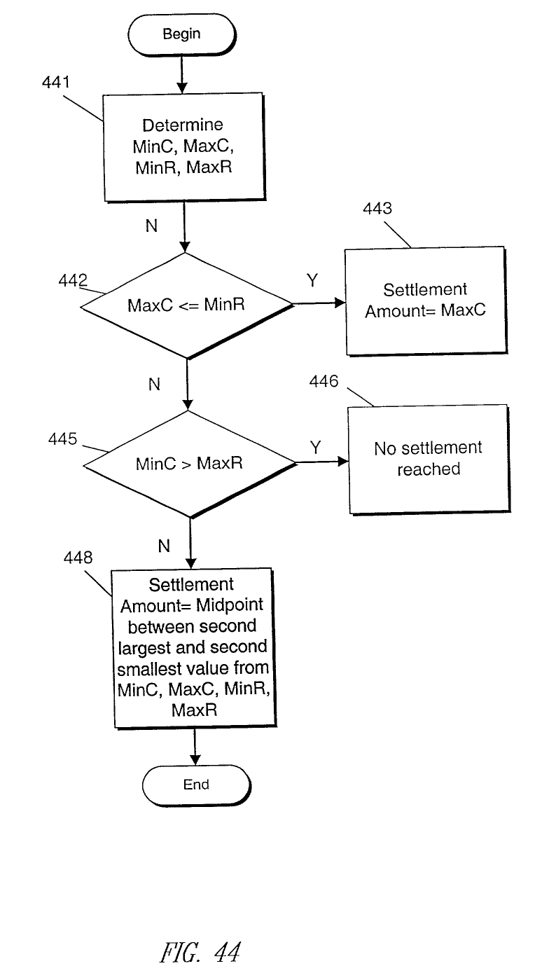

FIG. 44 is a flow diagram illustrating the logic used to determine a settlement value, according to one or more embodiments of the invention. For example, in one embodiment the system determines the upper and lower limits of settlement ranges offered by the claimant and the respondent, at step 441. Thus, four range limits are determined. They include the minimum amount accepted by a claimant (e.g., MinC), the maximum amount requested by the claimant (e.g., MaxC), the minimum payment offered by the respondent (e.g., MinR), and the maximum payment offered by the respondent (e.g., MaxR). If at step 442 the system determines that the maximum amount requested by the claimant is less than or equal to the minimum payment offered by the respondent, then the settlement value is calculated as the maximum amount requested by the claimant, at step 443. For example, if the claimant chooses a range of $1,000 to $2,000 to settle the claim and the respondent chooses a range of $4,000 to $8,000 to settle the claim, then the system calculates $2,000 as the settlement amount.

If at the step 445, the system determines that the minimum amount accepted by the claimant is more than the maximum payment offered by the respondent, then at step 446 the system determines that no settlement is reached (e.g., claimant's range is $10, 000 to $20,000 and the respondent's range is $5,000 to $8,000). Otherwise, the system at step 448 sorts the above four range limits either in ascending or descending order. Then, the system selects the midpoint between the second and third limits as the settlement amount. Thus, for example, if one party has selected a range of $1,000 to $3,000 and the other party has selected a range of $2,000 to $10,000 the system, in one embodiment, sorts the four limits from $1,000 to $10,000 (e.g., $1,000, $2,000, $3,000, and $10,000). The settlement amount is calculated as the midpoint between $2,000 (the second limit) and $3,000 (the third limit) at $2,500.

The same method can be applied to other circumstances where selected ranges overlap. For example, if both parties have selected the same exact settlement range (e.g., both claimant and respondent select $1,000-$3,000) then the dispute is resolved for the midpoint of that range (e.g., $2,000). If selected ranges are contiguous (e.g., claimant's selects $1,000 to $2,000 and respondent selects $2,000 to $10,000) then the settlement amount is the point of intersection (e.g., $2,000). Other methods for determining the settlement amount are possible. Provided below is an example of another method by which the settlement amount can be determining, according to an embodiment of the invention. As used below MinC is the minimum amount accepted by a claimant; MaxC is the maximum amount requested by the claimant; MinR is the minimum payment offered by the respondent; and MaxR is the maximum payment offered by the respondent:

if MaxC<=MinR then

Settlement Amount=MaxC

if MinR=MaxC then

Settlement Amount=MaxC

if MinR<MinC and MaxR>MinC and MaxR<MaxC then

Settlement Amount=MinC+((MaxR−MinC)/2)

if MinR>MinC and MinR<MaxC and MaxR>MaxC then

Settlement Amount=MinR+((MaxC−MinR)/2)

if MinR>MinC and MaxR<MaxC then

Settlement Amount=MinR+((MaxR−MinR)/2)

if MinR<MinC and MaxR>MaxC then

Settlement Amount=MinC+((MaxC−MinC)/2)

Appendix 1, attached, includes microfiche copies of computer code written in a computer readable language, according to one or more embodiments of the system. Appendix 1 includes other methods for determining the settlement amount. Appendix 1 and its entire content are a part of the present disclosure and are incorporated by reference in their entirety. One skilled in the art of computer programming can practice one or more aspects of the present invention by using the sample code disclosed in Appendix 1.

The system is implemented in one or more embodiments to provide for the resolution of multiparty disputes. In disputes involving multiple claimants and respondents the respondents need to agree on the proportionate degree of liability for the damages suffered by the claimant. Once the proportionate liability is determined between the respondents then a settlement amount is negotiated with the claimant. In certain cases, where the liability issue is clear one or all the multiple respondent may agree to offer a settlement amount to the claimant and later subrogate the liability issue among themselves.

In embodiments of the system, the respondents log on to the system and separately select a percentage of liability from a menu of ranges provided by the system. The range selected represents the minimum and maximum percentages of liability that a respondent is willing to accept with regards to damages suffered by the claimant. If the selected ranges can account for a total 100% liability then the respondents have reached an agreement on the issue of proportional liability. For example, consider a multiparty dispute wherein claimant A is seeking compensation from respondents B and C. If respondent B selects the range of 25% to 35% and respondent C selects the range of 65% to 75% then the system determines that respondents B and C can account for 100% of liability for damages suffered by A.

If the selected percentages do not account for a 100% liability between the respondents then the system provides the respondents with the option to proceed through continued rounds of negotiation until an agreed settlement percentage is reached. Once the respondents have agreed on the proportionate degree of liability between them, the system provides the respondents with a menu of settlement ranges as described earlier. Respondents acting as one respondent choose a settlement range from the menu provided by the system. The respondents may select an increment amount based on which various settlement ranges can be provided by the system. When the claimant is notified of the pending settlement offer by the respondents, the claimant selects a range representing the minimum and maximum dollar amount for which he or she is willing to settle his claim for damages. The system then proceeds in the same manner as it would proceed in the case of a non-multiparty dispute to calculate a settlement amount. If no settlement is reached, the system also provides for additional rounds of negotiation until the case is settled or negotiations are terminated.

In one or more embodiments, once a settlement amount is calculated by the system each respondent pays his predetermined percentage of the settlement amount to the claimant. Other methods may be possible. In a case involving multiple claimants respondents are provided with system tools to negotiate and agree on their proportionate degree of liability for damages to each claimant in a way similar to that described above. When the total percentage of liability for all respondents equals 100% then the system proceeds to provide the parties with the tools to negotiate on a settlement amount for each claimant.

Additionally, in one or more embodiment, the system includes features for data mining and aggregation that can provide the users of the system with valuable information and demographics. Utilizing one aspect of the invention, an insurer can use the system's information databases to measure the efficiency and workload of its employees. For example, by analyzing the information gathered by the system it can determine how quickly their claims adjusters are processing and settling claims. This is accomplished by the system tracking the date and amount of settlement offers, number of offers during negotiation, and the time elapsed before a final settlement was reached, according to one or more embodiments.

For example, claims adjuster A may be settling an automobile related injury claim in Northern California for $7,000 in a three months period, while claims adjuster B is settling a similar claim in Northern California for $7,500 in two weeks. The system can be utilized to generate a report to provide such information to a claim manager. This can assist the claims manager to encourage claims adjuster A to settle claims at $500 more because the savings in overhead and processing cost exceed the additional $500 of increased payment for the injury.

In embodiments of the system, the settlement process used by each claims adjuster can be analyzed and reviewed within each claims processing center or region. Thus, an insurer can utilize the system to measure the productivity of each of its claims processing centers, as well. For example, the system can be utilized to generate a report on the work habits of highly productive and efficient claims adjuster. Using the recorded data for each adjuster the system, for example, can process and track settlement behavioral patterns and share that information with other claims adjusters in order to raise the quality of work performed by adjusters in a processing center or across an entire company.

Furthermore, the system can utilize gaming theory and predictive software to determine the best or the most likely settlement values for each dispute based on the parties, the location that the matter may be litigated, and other demographic information. For example, the system may access and compile information regarding settlements and verdicts for a slip and fall case in the city of Los Angeles within the five years of the date of injury. The system can then calculate the average settlement reached for that particular injury within those five years and forward a message to alert parties that research and past experience shows that a settlement in the amount of $15,000, for example, is appropriate for the type of injury. The system may also generate a certain confidence factor for the settlement value quoted. The parties can choose to ignore the system's advice, however.

The system, in some embodiments, also tracks the initiation date and the settlement date of a case by type of claim. Currently, not all insurers can monitor the progress of their cases by type of claim. The system after compiling the information can provide the insurer with the ability to better manage their adjusters by setting certain settlement guidelines. For example if a particular personal injury case settles for $7,000 over three months, $500 can be added to the settlement offer as an incentive if it reduces the negotiation period from three months to two weeks.

The information gathered by the system can be also used to determine a more accurate financial reserve amount for an insurer. The financial reserve is the amount of money an insurer needs to keep in order to make payments for settled claims. Insurers estimate their financial reserve for expected claim payments based upon data that is an average of losses paid out in a particular region or the entire country. Insurers are not able to segment the estimate of losses by zip code. Insurers would be more accurate with the financial reserve estimate if they are better able to track and segment losses paid out by zip code or a specific region, for the following reasons.

Insurers estimate financial reserves based upon the amount of the claim and not necessarily on the actual loss payoff. The system can track the initial offer and demand, subsequent offers and demands and the final settlement amount. The initial demand is the amount of the claim made from which the insurer would estimate its financial reserve. The system's predictive software and gaming theory applications can provide the insurer with the likely settlement amount of the initial demand for a particular claim type. Knowing the likely settlement amount of a particular initial claim demand provides the insurer with more accurate data that allows the insurer to perhaps lower their financial reserve. By monitoring the particulars of offers and demands initiating via the system and final settlement values by zip code and region an insurer can have a more accurate estimate of the financial reserve needed for each area.

This invention takes advantage of the recent advances in computer and networking technology, especially the Internet, to provide parties to a dispute with efficient means to settle disputes. This invention, its advantages and improvements over the prior art schemes, will be better understood and appreciated by reviewing the following discussion of the Internet and computer networks.

Computer Networks and the Internet

The current invention in one or more embodiments is implemented to take advantage of the functionality provided by computer networks and the Internet. The following includes a brief discussion of how computers and various resources available on the Internet interact to implement the system of the current invention.

The Internet is a global computer network that provides the infrastructure for the World Wide Web or the WWW. The World Wide Web is a communication system that is composed of millions of files that contain links to other files stored on various connected computer networks. A computer network includes a group of computers or other devices linked together in a manner that promotes communicate between them. A computer network also may include resources such as printers, modems, and file servers. It may also include services such as electronic mail and file transfer. A computer network can be a small system that is physically connected by cables or several separate networks that are connected together to form a larger network, such as the Internet.

FIG. 4 illustrates a computer network, wherein a client computer 410 communicates with a server system 430 via an Internet connection 450. A server system (also known as a host computer) provides information to requesting computers (also known as clients) on a network. When a multitude of client computers communicate with the server system, such as it is the case with the Internet, it may be necessary to have more than one server system to handle client requests. An Internet client accesses a host computer on the worldwide network via an Internet service provider. An Internet service provider is an organization that provides a client with access to the Internet via analog telephone lines, Integrated Services Digital Network (ISDN) lines, optical cables, or other communication media.

Various protocols, services, and tools have been implemented to allow a client to retrieve information from or communicate with another computer on the Internet. Hypertext Transport Protocol (HTTP) is the standard protocol for communicating with an information server on the Internet. A protocol refers to a formal set of rules that must be followed in order for network computers to communicate. The HTTP protocol provides for communication methods that allow clients to request data from a server and send information to the server (e.g., downloading files, or sending electronic mail).

One of the most valuable and commonly used tools for communication over the Internet is a software application known as the browser. Examples of most popular browse that are currently available include Netscape Navigator, Microsoft Internet Explorer, Mosaic and Cello. As illustrated in FIG. 4, a browser 420 is a software application that runs on client computer 410 and provides a user-friendly environment in which a user can interact with computer 410 via a graphical user interface (GUI). A GUI allows the user to submit various requests or responses without having to learn or type complicated or unmemorable text commands. A browser requests, transfers, and displays information that is stored as files on the Internet.

Requests submitted by a client computer are processed by computer systems known as hosts or servers. A server that responds to client's request over the Internet is generally known as an HTTP server. In a typical client-server communication, client 410 transmits a request to the HTTP server 430 (e.g., GET an object from the server or POST data to an object on the server). HTTP server 430 responds to the client computer 410's request by forwarding a request status and the requested information.

A client request is, typically, a request for access to a resource on the host computer. The most commonly accessed resources are web sites and web pages. Web pages are interactive resources that provide a user with a graphical interface for either viewing or downloading information. An addressing scheme is employed to identify Internet web sites and other available resources. This addressing scheme is referred to as Uniform Resource Locator (URL). A URL is a string of characters that includes information about the location of a resource on the Internet, the type of service requested, and the method (i.e., protocol) of communicating with that resource. A URL also includes the address of the host server on the Internet (i.e., the initiating party address), port to which the server application connects (i.e., the port number), and location of the web site in the file structure of the server (i.e., the domain name and HTML file name).

A web site may include a number of graphically displayable pages of information that are linked together. A concept known as hypertext or hyperlinks is used for maneuvering and linking the multiple pages of a web site. A hypertext or a hyperlink provides the ability to move directly from one web site to another web site or to other information within the same site. To activate the link, it is only necessary to click on the hyperlink (e.g., a word or an icon on the web page). A URL associated with the link identifies the location of the additional information and the browser submits the URL information in a request to the server to access the data at the site specified in the URL.

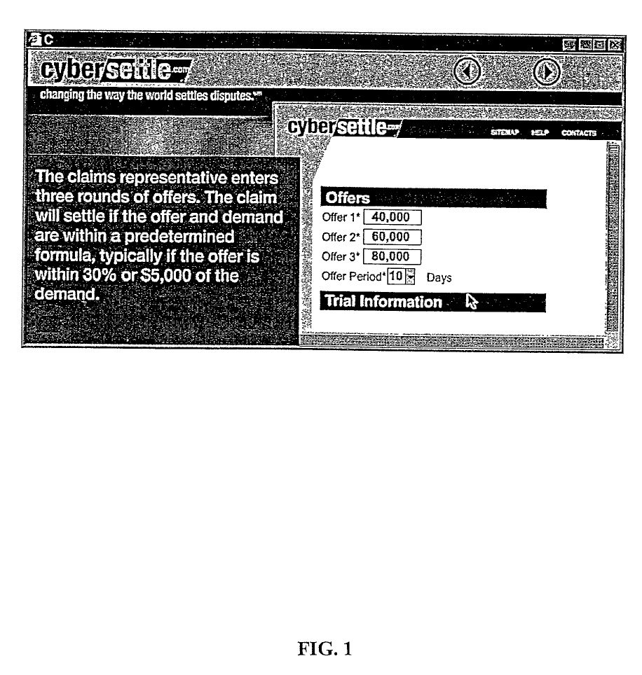

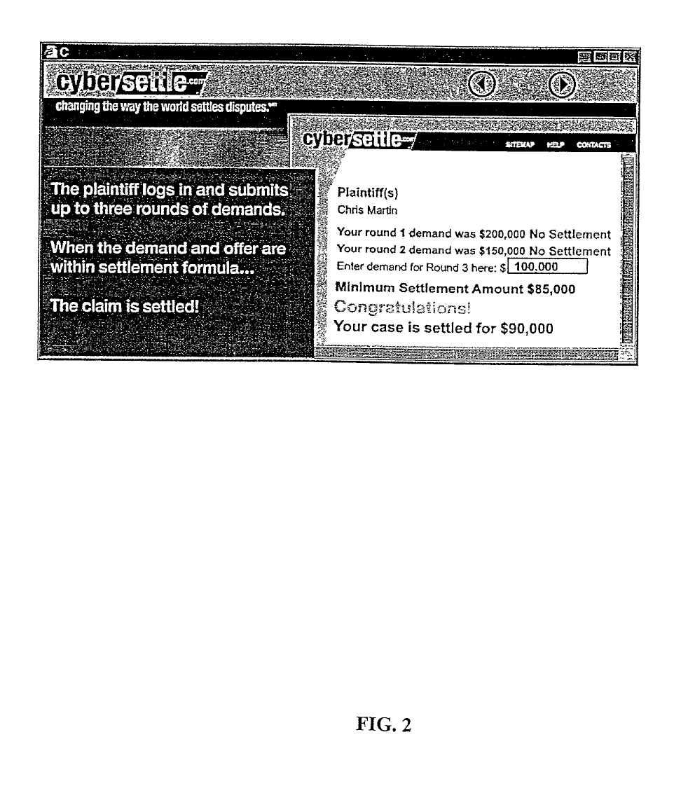

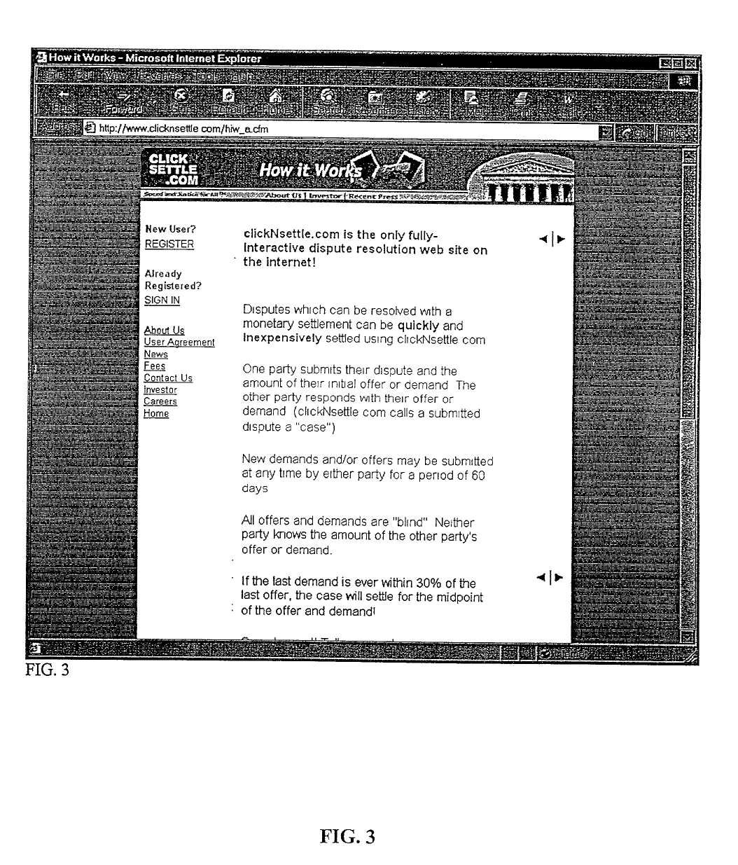

When a server receives a URL request, it first locates the web site referenced in the URL and then forwards the content of the web site to the requesting client. Referring to FIG. 1, the contents of a web site are currently created using a computer language called the Hypertext Markup Language (HTML). This content is saved as HTML files 140 on the server. Other languages such as Extensible Markup Language (XML) and the like are also used for creating web pages. An HTML document is a text file coded with predefined keywords (i.e., tags) and regions defined within those tags that allow a browser to identify and display different text or graphical information at a certain location on a web page. An example of the partial content of an HTML files is provided below.

<HTML>

<HEAD>

<TITLE>ResolveltNow.com</TITLE>

<SCRIPT LANGUAGE=“JavaScript”>

<META NAME=“keywords” CONTENT=“ADR”

function do something( ) {

}

. . .

</HEAD>

<BODY>

text and graphic information

</BODY>

</HTML>

The words enclosed in between the “<” and “>” constitute a tag that identifies a region of the HTML file. In the “HEAD” region, the title of the web page, java applets (for performing various functions), and other information about the web page may be defined. In the “BODY” region, all the text and other displayable information and the manner and location of their display on the web page are defined. A browser executing on a client computer upon receiving an HTML file parses its content and graphically displays the page on the client's computer screen, based on the information in the HTML document. Once the client has viewed the web page, the client can submit another request to view another web page on the Internet, or may interact with the web page by entering information in a dialog box, or clicking on a button, for example.

System Hardware Environment

An embodiment of the invention that includes the system and application software can be implemented as computer software in the form of computer readable code executed on a general-purpose system such as system 510, illustrated in FIG. SA. System 510 may comprise a central processor unit 501, a main memory 502, an input/output controller 503, optional cache memory 504, user interface devices 505 (e.g., keyboard, mouse, microphone, camera), storage media 506 (e.g., hard drive, flash memory, floppy, optical, or magneto-optical disks), a display screen 507, a communication interface 508 (e.g., a network card, a modem, or an integrated services digital network (ISDN) card), and a system synchronizer (e.g., a clock, not shown in FIG. 5A).

Processor 501 may or may not include cache memory 504 utilized for storing frequently accessed information. One or more input/output devices such as a printing or a scanning device may be included in system 510. A communication means, such as a bi-directional data bus 500, can be utilized to provide a mechanism for communication between the system components. The system itself may be capable of communicating with other systems through communication interface 508.

In one or more embodiments of the invention, depending on the communicational needs of the user, system 510 may not include all the above components. In other embodiments system 510 can include additional components for users who require additional functionality from the system. For example, system 510 can be a laptop computer or a cellular communication device that can send messages and receive data through communication interface 508. In some embodiments the data can include program code.

In some embodiments of the invention wireless links are also possible. In any such implementation, communication interface 508 can send and receive electrical, electromagnetic or optical signals that carry digital data streams representing various types of information. If communication is established via the Internet, a remote server system might transmit the requested code for an application program through an Internet connection to the communication interface 508. The received code is executed by central processor unit 501 as received or is stored in storage media 506 or other non-volatile storage for later execution.

System 510 may obtain program code, for example, in form of code transmitted via a carrier wave. Program code may be embodied in any other form of computer program product, however. A computer program product comprises a medium configured to store or transport computer readable code or a medium in which computer readable code may be embedded. Some examples of computer program products are CD-ROM disks, ROM cards, floppy disks, magnetic tapes, computer hard drives, network server systems, and carrier waves.

In one or more embodiments of the invention, processor 501 is a microprocessor manufactured by Motorola or a microprocessor manufactured by Intel, such as a Pentium processor, or a SPARC microprocessor from Sun Microsystems, Inc. The named processors are for the purpose of example only. Any other suitable microprocessor or microcomputer may be utilized. The system hardware environment may be embodied in the form of a computer system, a set-top box, a personal data assistant (PDA), a wireless mobile communication unit, or other similar hardware environments that have information processing and/or data storage capabilities.

System Software Environment

FIG. 5B illustrates a computer software system 520 suited for managing and directing the operation of system 510, for example. System software 520 is, typically, stored in storage media 506 and is loaded into memory 502 prior to execution. It includes an operating system (OS) 521 that controls the low-level operations of system 510. Low level operations include the management of the system's resources such as memory allocation, file swapping, and other core computing tasks. In one or more embodiments of the invention, operating system 521 is Microsoft Windows 98, Microsoft Windows NT, Macintosh OS, or IBM OS/2. However, any other suitable operating system may be utilized.

One or more computer programs, such as client software application 522, are executed on top of the operating system 521 after they are loaded from storage media 506 into memory 502. Client software application 522 may include a web browser software 523 for communicating with the Internet. Software system 520 includes a user interface 524 (e.g., a Graphical User Interface (GUI)) for receiving user commands and data. The commands and data received are processed by the software applications that are running on the computer system 510.

The system architectures and environments described above are for purposes of example only. Embodiments of the invention may be implemented in any type of system architecture or processing environment. For example, in some embodiments of the invention the system software may be hardwired into the hardware environment or implemented within non-volatile memory devices. Thus, methods, systems, and apparatus for resolving disputes have been described according to one or more embodiments. Other embodiments of this invention will be obvious to those skilled in the arts in view of the above disclosure.

1. A method of resolving a dispute comprising:
providing for one or more initiating parties to initiate one or more offers comprising one or more first settlement ranges;
notifying one or more responding parties that one or more offers are initiated;
providing for the responding parties to initiate one or more responses comprising one or more second settlement ranges; and
determining a settlement amount based on the first and second settlement ranges.

2. A method of resolving a dispute using an on line system, said method comprising:
an on line system providing for an initiating party to initiate an offer to settle a dispute, said offer comprising a first settlement range;
the on line system notifying a responding party that that the offer is initiated;
the on line system providing for the responding party to initiate a response to settle the dispute, said response comprising a second settlement range; and
the on line system notifying the initiating and responding parties whether a settlement is reached based on the first and second settlement ranges.

3. The method of claim 2 further comprising:
the on line system providing for the initiating party to expand said first settlement range if a settlement is not reached.

4. The method of claim 3 further comprising:
the on line system notifying the initiating and responding parties whether a settlement is reached based on the expansion of the first settlement range.

5. The method of claim 4 further comprising:
the on line system providing the responding party to expand said second settlement range if a settlement range is not reached based on the expansion of the first settlement range.

6. The method of claim 5 further comprising:
the on line system notifying the initiating and responding parties whether a settlement is reached based on the expansion of the second settlement range.

7. The method of claim 6 further comprising:
the on line system periodically inviting one or both the initiating party and the responding party to resubmit new offers if a settlement is not reached.

8. The method of claim 7 further comprising:
the on line system notifying a party and that unless a new offer for settlement is submitted by a certain deadline any pending settlement offers will be withdrawn.

9. The method of claim 8 further comprising:
the on line system terminating all services provided if a settlement is not reached after a certain time period has elapsed.

10. The method of claim 9 further comprising:
the on line system providing the initiating and responding parties with a communication forum to communicate.

11. The method of claim 1 wherein:
a settlement is reached if the first and second ranges overlap.

12. The method of claim 1 wherein:
a settlement range represents an offer made by a claimant and another settlement range represents an offer made by a respondent for resolution of a dispute; the settlement range offered by the claimant comprising a minimum limit accepted by the claimant and a maximum limit requested by the claimant; the settlement range offered by the respondent comprising a minimum limit offered by the respondent, and a maximum limit offered by the respondent;
wherein if the maximum limit requested by the claimant is less than or equal to the minimum limit offered by the respondent, then the settlement amount is the maximum limit requested by the claimant.

13. The method of claim 12 wherein:
if the minimum limit accepted by the claimant is more than the maximum limit offered by the respondent then no settlement amount is determined.

14. The method of claim 13 wherein:
the settlement amount is a value between the second largest and second smallest limits selected from settlement ranges offered by the claimant or the respondent.

15. The method of claim 13 wherein:
the settlement amount is the midpoint between the second largest and second smallest limits selected from settlement ranges offered by the claimant or the respondent.

16. The method of claim 13 further comprising:
inviting the claimant and the respondent to expand the settlement ranges representing their offers of settlement, if no settlement amount is determined.

17. The method of claim 16 further comprising:
expanding the settlement range offered by the claimant by a percentage of the difference between the upper and lower limits of the settlement range offered by the claimant, if the claimant elects to expand the settlement range.

18. The method of claim 17 further comprising:
determining a settlement amount based on the expanded settlement range.

19. The method of claim 16 further comprising:
expanding the settlement range offered by the respondent by a percentage of the difference between the upper and lower limits of the settlement range offered by the respondent, if the respondent elects to expand the settlement range.

20. The method of claim 19 further comprising:
determining a settlement amount based on the expanded settlement range.

21. A method of resolving a dispute between an initiating party and a responding party comprising:
providing for an initiating party to select a first increment value;
providing for the initiating party to select a first settlement range from a plurality of settlement ranges generated based on the first increment value; and
providing for an initiating party to initiate an offer to settle a dispute, said offer comprising the first settlement range.

22. The method of claim 21 further comprising:
notifying a responding party that the offer is initiated;
providing for the responding party to select a second settlement range from a plurality of settlement ranges generated based on the first increment value; and
providing for the responding party to initiate a response to settle the dispute, said response comprising the second settlement range.

23. The method of claim 21 further comprising:
notifying a responding party that the offer is initiated;
providing for the responding party to select a second increment value;
providing for the responding party to select a second settlement range from a plurality of settlement ranges generated based on the second increment value; and
providing for the responding party to initiate a response to settle the dispute, said response comprising the second settlement range.

24. The method of claim 21 wherein:
the initiating party may select an exact settlement value as the first settlement range.

25. The method of claim 22 wherein:
the responding party may select an exact settlement value as the first settlement range.

26. The method of claim 22 wherein:
a settlement value is determined based on the first and second settlement ranges.

27. A computer program product comprising:
a computer usable medium having computer readable program code embodied therein configured to resolve a dispute, said computer program product comprising:
computer readable code configured to cause a system to provide for an initiating party to select a first increment value;
computer readable code configured to provide for the initiating party to select a first settlement range from a plurality of settlement ranges generated based on the first increment value; and
computer readable code configured to provide for an initiating party to initiate an offer to settle a dispute, said offer comprising the first settlement range.

28. The computer program product of claim 27, further comprising:
computer readable code configured to notify a responding party that the offer is initiated;
computer readable code configured to provide for the responding party to select a settlement range from a plurality of settlement ranges generated based on the first increment value; and
computer readable code configured to provide for the responding party to initiate a response to settle the dispute, said response comprising the second settlement range.

29. The computer program product of claim 27, further comprising:
computer readable code configured to notify a responding party that the offer is initiated;
computer readable code configured to provide for the responding party to select a second increment value;
computer readable code configured to provide for the responding party to select a second settlement range from a plurality of settlement ranges generated based on the second increment value; and
computer readable code configured to provide for the responding party to initiate a response to settle the dispute, said response comprising the second settlement range.

30. The computer program product of claim 27, wherein:
the initiating party may select an exact settlement value as the first settlement range.

31. The computer program product of claim 28, wherein:
the responding party may select an exact settlement value as the first settlement range.

32. The computer program product of claim 28, wherein:
a settlement value is determined based on the first and second settlement ranges.

33. A computing system for resolving disputes, said system comprising:
a processor;
a memory coupled to said processor;
code executed by said processor configured to resolve a dispute; said code comprising:
a method providing for an initiating party to select a first increment value;
a method providing for the initiating party to select a first settlement range from a plurality of settlement ranges generated based on the first increment value; and
a method providing for an initiating party to initiate an offer to settle a dispute, said offer comprising the first settlement range.

34. The system of claim 33 said code further comprising:
a method notifying a responding party that the offer is initiated;
a method providing for the responding party to select a second settlement range from a plurality of settlement ranges generated based on the first increment value; and
a method providing for the responding party to initiate a response to settle the dispute, said response comprising the second settlement range.

35. The system of claim 33 said code further comprising:
a method notifying a responding party that the offer is initiated;
a method providing for the responding party to select a second increment value;
a method providing for the responding party to select a second settlement range from a plurality of settlement ranges generated based on the second increment value; and
a method providing for the responding party to initiate a response to settle the dispute, said response comprising the second settlement range.

36. The system of claim 33, wherein:
the initiating party may select an exact settlement value as the first settlement range.

37. The system of claim 34, wherein:
the responding party may select an exact settlement value as the first settlement range.

38. The system of claim 34, wherein:
a settlement value is determined based on the first and second settlement ranges.

39. The system of claim 38, wherein:
the initiating and responding parties are invited to expand the settlement ranges representing their offers of settlement, if no settlement offer is determined.

40. The system of claim 39 said code further comprising:
a method expanding the settlement range offered by the initiating or the responding parties by a percentage of the difference between the upper and lower limits of the settlement range offered by the parties in order to reach a settlement.
